(19) United States
(12) Patent Application Publication
(10) Pub. No.: US 2004/0009459 A1
(43) Pub. Date: Jan. 15, 2004

(54) Simulation system for medical procedures

(76) Inventors: James H. Anderson, Cloumbia, MD (US); Anthony C. Venbrux, Washington, DC (US); Kieran P. Murphy, Baltimore, MD (US); Meiyappan Solaiyappan, Ellicott City, MD (US); Chee-Kong Chui, Singapore (SG); Zirui Li, Singapore (SG); Xin Ma, Singapore (SG); Zhen L. Wang, Singapore (SG); Jeremy Teo, Singapore (SG)

Correspondence Address: EDWARDS & ANGELL, LLP, P.O. BOX 9169, BOSTON, MA, 02209, US

(21) Appl. No.: 10/430,363

(22) Filed: May 5, 2003

Related U.S. Application Data
(60) Provisional application No. 60/378,433, filed on May 6, 2002.

(51) Int. Cl. G09B 23/28

(52) U.S. Cl. 434/262; 703/11

(57) ABSTRACT

The invention provides a system for the simulation of image-guided medical procedures and methods of using the same. The system can be used for training and certification, pre-treatment planning, as well therapeutic device design, development and evaluation.

### RELATED APPLICATION

This application claims priority under 35 U.S.C. § 119(e) to U.S. Provisional Application No. 60/378,433, filed May 6, 2002, the entirety of which is incorporated by reference herein.

### FIELD OF THE INVENTION

The invention relates to a system, software, and method for simulating interactions between a medical device and one or more tissues during a medical procedure, such as a needle-based procedure. Simulations can be used to plan a treatment regimen using patient specific data.

### BACKGROUND OF THE INVENTION

Image-guided medical procedures, such as minimally invasive percutaneous medical procedures, require use of medical images in conjunction with delicate and complex hand-eye coordinated movements, spatially unrelated to the view on a TV monitor of the interventional devices being used to implement the procedures. Depth perception is lacking on the flat TV display, and it may be difficult to learn to control the tools through the spatially arbitrary linkage. A mistake in this difficult environment can be dangerous. Failure to properly orient or position a medical device within the patient may result in the serious injury to vessels, organs, or other internal tissue structure of the patient. Without performing the procedures often in patients, it is difficult for a health care worker, such as a physician, to maintain the high degree of skill needed to perform these procedures or to implement new methods, operations and procedures. In addition, there is currently no way for physicians to realistically evaluate different approaches to treatment options for patient specific situations prior to actually performing the procedures in the patient.

Systems for simulating medical procedures have provided important training tools that allow physicians to develop skills that can be transferred to the operating room. Such systems allow health care workers to practice the delicate eye-hand coordinated movements needed to navigate medical devices while viewing scanned images of a patient's anatomy on a display screen.

Simulation systems have been described which enable a user to track the placement of a medical device through the use of a display screen which displays a representation of a patient's anatomy. See, e.g., U.S. Pat. No. 6,038,488, WO 99/16352, and WO 98/03954. Systems also have been described which provide haptic feedback in response to a simulated medical procedure. See, e.g., WO 99/17265. U.S. Pat. No. 6,106,301 describes a radiology interface apparatus and peripherals, such as mock medical instruments, for simulating performance of a medical procedure on a virtual patient. The interface measures manipulations of system peripherals and transfers these measurements via a processor to a medical procedure simulation system. WO 98/09589 discloses an interface for simulating a needle-based medical procedure such as the administration of an epidural anesthesia and describes that haptic feedback may be used to simulate profiles of tissue encountering the needle.

In addition, Anderson and Raghavan, Min. Invas. Ther. & Allied Technol. 6: 111-116, 1997, report an interventional radiology simulator, da Vinci, for performing vascular catherization and interventional radiology procedures in a virtual patient for augmenting training and enhancing pretreatment planning. In the da Vinci system, a catheter is modeled using incremental Finite Element Modeling (FEM) while a vessel wall is represented by a potential field defining a region enclosing the vessel wall. A catheter interface device is provided which consists of a position/rotation measurement system, a mechanical system and a micro controller. A virtual catheter is displayed on a display monitor of a computer, which is advanced, retracted and/or twisted through the lumen of a blood vessel as a user manipulates the simulator catheter which is part of the interface.

Kockro, et al., Neurosurgery 46(1): 118-137, 2000, describes preoperative neurosurgical planning using a virtual reality environment using the Virtual Intracranial Visualisation and Navigation system (VIVIAN) and reports that the system includes tools for simulating bone drilling and tissue removal. The system co-registers MRI, MRA and CT data into a three-dimensional data set. Krocko, et al., describes difficulties in using the system to model soft tissue interactions and bone.

### SUMMARY OF THE INVENTION

There is a need to for a system for providing a highly realistic simulation environment for simulating insertion of a medical device through one or more tissues of the body, such as occurs during image-guided needle-based medical procedures (e.g., such as vertebroplasty, an orthoscopic procedure and the like). The simulation system provides a user with the capability to practice and/or preplan a diagnostic and/or treatment method using patient specific data sets prior to performing the actual procedure in a patient.

In one aspect, the invention provides a system, software and method for modeling interactions between a medical device and a tissue while taking into account the biomechanical properties of a tissue as well as the physical properties of the medical device. Preferably, the system and software simulates the interaction of a medical device with a tissue or organ having heterogeneous biomechanical properties and/or simulates interactions between a medical device and a plurality of tissues having different biomechanical properties.

The system provides a virtual imaging and surgery environment for image-guided medical procedures without exposure to X-Ray. In addition to providing realistic visual feedback and providing mechanisms that allow a user to interact with essential devices used in image-guided therapy, the simulator also provides active haptic force and tactile feedback components to enhance the total hand-eye coordinated experiences encountered by health care workers during actual intervention procedures. To simulate the various types of procedures, the invention also provides a novel solution to easily configure or customized the training or pretreatment planning environment to meet the needs of the user or trainer

In one aspect, the system provides a virtual display of generic or patient specific three-dimensional tissue models (e.g., such as bone, soft tissue, and the like) created from the various medical imaging devices. Such tissue models additionally may include models of fluid-filled spaces, cavities or lumens within the body of a patient.

The invention can be used to simulate a number of different types of procedures, in which a medical device may need to navigate/be inserted into different tissue types, including tissue types having different biomechanical properties. For example, the simulation system can be used to simulate vertebroplasty, an orthoscopic procedure, biopsy, and the like. The system also may be used to simulate the delivery of various therapeutic and/or diagnostic agents, including, but not limited to: nucleic acids (e.g., genes, antisense molecules, ribozymes, triple helix molecules, aptamers, etc.); proteins, polypeptides, peptides; a drug; a small molecule; an imaging agent, a chemotherapeutic agent, a radiotherapeutic agent and combinations thereof. In one aspect, the system further simulates the biological impact of delivery of one or more agents on one or more tissues of the body and/or of the effects of a therapeutic regimen (e.g., such as a regimen employing heat, light, microwave, ultrasound, electroporation, exposure to an electric field, photodynamic therapy, microwaves, x-ray therapy, and heat, etc.).

In another aspect, the system provides a medical device interface with insertion points for receiving a medical device such as a needle (e.g., such as used for a vertebroplasty procedure, an orthoscopic procedure, biopsy procedure, delivery of a therapeutic agent, etc.). Preferably, the interface includes a tracking mechanism that can receive and/or transmit signals relating to the position and/or interactions of the medical device with the interface. These interactions simulate interactions that might occur during the procedure, by providing haptic feedback as the same interactions are modeled on a graphical user interface of the system. Preferably, the system includes tracking software that provides for continuous tracking of the medical device as it moves and/or interacts with the interface, enabling the system to model and display the changing interactions of the device with one or more tissues of the patient's body on the graphical interface.

The medical device interface may comprise a biomechanical model of a patient (e.g., such as a manikin) or a portion of a patient to enhance the realism of the simulation. In one aspect, the simulation system provides at least one force feedback mechanism that consists of an assembly of servo motor and encoders, or an air pressure controller that can be placed inside the manikin. In another aspect, the force feedback is directional, i.e., the user can reverse or change the directionality or rate/force of motion when the haptic interface component senses an obstruction or impingement to the forward movement of an inserted device. The manikin may include one or more insertion points for receiving one or more medical devices.

Alternatively, the interface may merely provide the necessary haptic feedback and tracking mechanisms necessary for the simulation. For example, the interface may comprise a robotic arm programmed to provide resistance to a user's manipulation. In one aspect, the interface comprises a frame which includes a needle-positioning instrument that allows a user to define the insertion parameters of needle placement and/or injection. The interface alternatively may comprise a unit substituting for a medical device (e.g., such as a joystick, mouse, or other instruments) for receiving haptic feedback from the system. In certain aspects, the system comprises a plurality of medical device interfaces. In one aspect, the system comprises at least a first and second interface. In another aspect, the second interface is remote from the first interface and allows a second user of the second interface to experience the same haptic feedback that a first user is experiencing at the first interface.

The invention provides a unique software model for image-guided medical therapeutic procedures. This physical based model of patient body used to generate the variables (force and slight vibration) necessary for haptic interface control and realistic visualization made up of volumetric spatial data structure derived from medical images of patient, and hence, patient specific. Collision detection of the model is determined with geometrical model of stiff needles. Surface deformation of the hard and soft tissues is computed using finite element method assuming physical constraints due to friction and gravity.

The system uses knowledge-based systems to relate image variables and to make recommendations on the trajectory and deformation of the medical devices utilized based on the physical and biological target treatment tissue properties

The system provides a functional environment to train individuals in needle or instrument guided diagnostic and therapeutic procedures using a virtual patient setting as opposed to the actual patient. The system also allows individuals to pre-plan various treatment approaches using patient specific data sets in order to reduce complications or improve therapy delivery for subsequent real patient treatment. The system also may be used in a tele-mentoring or tele-educational function to allow individuals from remote sites to advise or interact in the simulation process in order to provide expert advice or be expose to educational opportunities. In one aspect, the system comprises one or more client processors connectable to a network server to facilitate a web-implemented simulation that can be used for training and/or pretreatment planning.

Accordingly, in one aspect, the invention provides a system comprising: a database comprising data for generating a geometric model of at least one tissue or organ and a biomechanical model of the at least one tissue or organ and a program for displaying an image of the at least one tissue or organ and for simulating interactions between a medical device and the tissue or organ. In one aspect, the database comprises data necessary to model a tissue or organ with heterogeneous or changing biomechanical properties. In another aspect, the database comprises data to model a plurality of different tissues and/or organs, taking into account their biomechanical properties and interactions with one or more medical devices. In one preferred aspect, the database comprises patient-specific data relating to a patient to be treated enabling a user of the system to simulate a medical procedure he or she is going to perform on that patient. Preferably, the database is updated at selected time-intervals, e.g., at least about every five minutes, at least about every minute, at least about every thirty seconds. More preferably, collection occurs in real-time, and images are reconstructed by the system which models biomechanical interactions between tissue(s) and a medical device over selected time intervals as described above.

In one aspect, an expert, remote from the user's site (i.e., the site of a processor being used by the user) interacts with the system via a web-based interface to monitor and/or alter various aspects of the user's simulation (e.g., to improve or provide input into a treatment regimen being planned). In another aspect, the system is in communication with one or more robotic devices for implementing a treatment regimen on a patient and a user of the system receives haptic feedback through an interface in communication with the one or more robotic devices.

In still another aspect, the invention provides a system comprising: an expert module comprising a database comprising data relating to biomechanical properties of at least one tissue or organ; and a program for simulating a treatment method implemented by a medical device interacting with the at least one tissue or organ. Preferably, the database comprises data relating to at least one tissue with heterogeneous or changing biomechanical properties. In one aspect, the database comprises data relating to a plurality of different tissues and or organs.

In one aspect, the at least one tissue type comprises a pathology. For example, the at least one tissue or organ may be from a patient to be treated for a condition using the medical device. In another aspect, the at least one tissue type comprises an injury or wound. In a further aspect, the pathology or injury is a pathology or injury affecting bone. For example, the system may be used to simulate injuries related to osteoporosis or cancer, such as compressive fracture of the vertebrae and the database comprises data relating to biomechanical properties of bone effected by such pathologies or injuries. In a further aspect, the system is used to simulate osteonecrosis, a condition resulting from poor blood supply to an area of bone causing bone death or bone resorption, as occurs in Kummel's disease.

Preferably, the systems according to the invention further comprise a knowledge base regarding biomechanical properties of the at least one tissue or organ. Also, preferably, the knowledge base comprises data relating to properties of tissues or organs from a plurality of patients. In one aspect, the knowledge base comprises data relating to the interaction of a medical device with the at least one tissue or organ from at least one patient.

As discussed above, the system may comprise an interface for simulating contact between a user and the medical device. The interface may be remote from a computer memory comprising the database. However, generally, the interface communicates with the computer memory through a processor in communication with the database.

Preferably, systems of the invention comprise program instructions for simulating an operation of a medical device on the body of a patient to treat the patient for a condition. The operation may comprise insertion of the medical device into the at least one tissue or organ and/or may comprise injection of a material into a patient and/or removal of a biological material from a patient (such as a material comprising at least one cell comprising a pathology, e.g., a cancer cell). In one aspect, the operation comprises insertion of the medical device into plurality of tissues, including tissues with different biomechanical properties. In another aspect, the system simulates movement by an organ or tissue upon interaction of a medical device with a tissue. For example, the system simulates deformation of a tissue as a needle is inserted and/or movement of an organ as a medical device is pushed against or inserted into the organ or a neighboring tissue.

In one aspect, the interface comprises a medical device and a manikin for receiving the medical device. In another aspect, the interface comprises a robotic arm coupled to a medical device. In still another aspect, the interface comprises a needle assembly. Preferably, the needle assembly comprises a curved frame, providing at least 6 degrees of freedom.

In preferred aspects of the invention, the interface comprises a mechanism for simulating resistance against insertion and/or movement of the medical device. More preferably, the mechanism is capable of varying the resistance in response to a feedback signal from a system processor. In one aspect, the resistance varies according to the simulated placement of the medical device in a given tissue type. In another aspect, the mechanism for varying resistance comprises a device for varying air pressure within the interface. In still another aspect, the interface comprises a mechanism for providing continuous haptic feedback. Preferably, the interface comprises a mechanism for providing directional feedback.

In one aspect, the system is used to simulate an image-guided procedure. Various forms of imaging may be simulated, as are known in the art, including but not limited to MRI, MRA, tomography (e.g., CT, PET, etc), X-ray, fluorography, and the like. In certain aspects therefore, the system additionally includes one or more simulated scanning systems which resemble devices used in such procedures. The scanning system(s) may be movable to within a scanning distance of a simulated patient, such as a manikin and movement of the one or more scanning systems may be controlled by a system processor.

The system generally includes a graphical interface in communication with the database, such as for displaying an image of at least one tissue or organ. Preferably, the image comprises a plurality of tissues. In one aspect, the image displayed includes an image of trabecular or cancellous bone of the spine. Preferably, the image is a volume rendered image. More preferably, the image is generated by Finite Element Modeling (FEM) or another imaging modality which is used to calculate the interactions between a medical device and at least one tissue over time and which displays such interactions in real time. Preferably, the graphical interface displays images simulating use of the medical device to treat a condition of the at least one tissue or organ.

In one aspect, the system models interactions between simulated tissue(s) and medical device(s) that occur when a procedure is implemented without complication. Alternatively or additionally, the system may model interactions that occur when complications occur, such as when the device breaks a blood vessel, cuts or deforms tissue, breaks or cracks bone or cartilage, etc. In another aspect, the system simulates the movement of a tissue or organ that occurs upon insertion of a medical device, such as a needle, into the tissue or organ or into a neighboring tissue or organ.

In a further aspect, the graphical interface displays one or more controls for controlling the movement and/or operations of the medical device. Preferably, the interface enables a user of the system to reconfigure the interface to display controls appropriate for an instrument panel relating to an appropriate medical device being used and/or appropriate for one or more peripheral instruments in communication with the system such as mock or real scanning devices.

Preferably, the systems of the invention further comprise an information management system for managing data within one or more databases of the system. In one aspect, the information management system comprises a search engine for retrieving data relating to a tissue or organ in response to a query from a user of the system. In another aspect, the information management system is capable of comparing data relating to different tissues and/or organs. In a further aspect, the system is able to search for and retrieve selected image files in response to a query, such as a query relating to patient parameters. For example, the system, in response to a request for images of tissues showing similar anatomical and physiological parameters as a test image (i.e., a patient system) will deploy the information management system to search for, select, retrieve and display the appropriate related image(s).

The invention also provides a computer readable media containing program instructions for planning a treatment method implemented by a medical device, such as a needle. In one aspect, the computer readable media contains program instructions comprising: first computer program code for identifying an interface in communication with a processor, wherein the interface is capable of simulating contact between a user and the medical device and a second computer program code for running an application, the application comprising instructions for simulating an operation of the medical device on at least one tissue or organ in the body of a patient for modifying a condition of the patient.

In one aspect, the condition comprises a pathology and the operation comprises a method of treating the pathology. Operations that can be simulated using the computer readable medium include, but are not limited to: incision; dissection; injection; pinching, cutting, suturing, vertebroplasty; an orthoscopic procedure; biopsy; angiography; venography; arteriography; vertebral puncture; administration of an anesthetic such as during an epidural injection, delivery of therapeutic agents, grafting, transplantation, implantation, cauterization, reconstruction and the like. Operations may also include release of heat, light, ultrasound, microwaves, x-rays, or an electric field from the device.

In one preferred aspect, the computer readable medium comprises program instructions for simulating vetebroplasty, including at least a first computer program code for displaying one or more images of the spine, a second computer program code for executing a simulation of placement of a needle into a vertebral body, and a third computer program code for simulating injection of cement (e.g., a radiopaque biocompatible bone cement such as methyl methcrylate) to stabilize the vertebral body. Preferably, the computer readable medium contains program code for simulating bone cement injection in real-time. Also preferably, the computer readable medium executes instructions for modeling the biomechanical properties of the vertebral body and for displaying a volumetric data structure representing the vertebral body on a graphical user interface of the system. In one aspect, the computer readable medium comprises computer program code for calculating amounts of force to be fed back to a user of the simulation system, for calculating deformation of one or more body structures and/or fluid flow.

In another aspect, the computer readable medium further comprises a third computer program code for receiving inputs from the interface and for modifying the simulation based on the inputs. In a further aspect, the computer readable medium further comprising program code for receiving and processing patient data, such as data received over the internet. Preferably such data comprises data relating to biomechanical properties of at least one tissue or organ in the patient.

Additionally, the invention provides a method for planning a treatment implemented by a medical device (such as a needle). In one aspect, the method comprises: providing a database comprising data relating to biological properties of at least one tissue or organ; performing at least one step of simulating the interaction of the medical device with the at least one tissue or organ, such as insertion of the device into at least one tissue; and operating the medical device to effect a treatment based on the simulating step. In another aspect, the method further comprises the step of simulating insertion of the device into a plurality of different tissues comprising different biomechanical properties. The method may comprise simulated insertion of a medical device into a lumen. However, in one aspect, the method comprises the step of simulating insertion of a medical device into at least one tissue, and preferably through multiple different tissue types comprising different biomechanical properties (e.g., such as skin, muscle, fat, bone, etc.).

In one aspect, the method comprises the step of simulating injection of a material into at least one tissue using the medical device. Alternatively or additionally, the method comprises the step of simulating removal of a biological material from a patient (e.g., blood, tissue, such as a tumor, an organ, etc.).

Preferably, the database comprises data relating to a patient to be treated using the medical device.

Preferably, the step of simulating the interaction between the device and at least one tissue comprises displaying one or more images of interactions between the medical device and at least one tissue.

In one aspect, the method comprises providing an interface for simulating contact between a user and a medical device wherein contact with the interface by the user alters display of the interaction. Preferably, display is altered in real time as the user interacts with the interface and/or as the system models biomechanical and functional changes in the anatomy of the patient.

In one aspect, the method further comprises providing haptic feedback to the user through the interface which models the tactile experiences of a user during the treatment operation.

### BRIEF DESCRIPTION OF THE FIGURES

The objects and features of the invention can be better understood with reference to the following detailed description and accompanying drawings.

FIG. 1 is a block diagram illustrating a schematic of a simulation system according to one aspect of the invention.

FIG. 2 is a schematic diagram showing a simulation process according to one aspect of the invention.

FIG. 3 illustrates manual segmentation of contours in a simulation method according to one aspect of the invention.

FIG. 4 shows generation of a 2D mesh in a simulation method according to one aspect of the invention.

FIG. 5 shows generation of a 3D in a simulation method according to one aspect of the invention.

FIG. 6 shows generation of subdomains according to one aspect of the invention.

FIGS. 7A-G shows that varying the number of nodes in a subdomain before node differentiation can vary the accuracy of the subdomain characterization.

FIGS. 7A-G illustrate increasing accuracy in each panel with FIG. 7G representing 100% accuracy.

FIGS. 8A-F illustrate how the simulation process maintains connectivity between different tissue elements during the modeling process. The different panels illustrate sagittal sections through vertebral bone. In the FE model shown, two regions are classified, an outer region and inner region (colored in brown) which are assigned different material properties.

FIGS. 9A-G illustrates a simulation process for simulating a target region comprising a plurality of tissues with different biomechanical properties.

FIG. 10 shows a medical device interface and system workstation according to one aspect of the invention.

FIG. 11 shows a medical device interface and system workstation according to another aspect of the invention.

FIG. 12 shows a medical device interface according to another aspect of the invention in which the device interface comprises a robotic arm.

FIG. 13 shows a medical device interface according to one aspect of the invention comprising a needle assembly.

FIG. 14 shows an enlarged view of the needle portion of the needle assembly shown in FIG. 13 and tracking and force feedback mechanisms provided in the medical device interface.

FIGS. 15A and B show system workstations for simulating a vertebroplasty procedure according to one aspect of the invention.

FIG. 16 shows a force feedback mechanism using a controllable air pressure mechanism.

FIG. 17 illustrates building a volume-based potential field according to one aspect of the invention.

FIGS. 18A and B show mapping parameters for a cement injection model for simulating a vertebroplasty procedure according to one aspect of the invention.

FIG. 19 illustrates density differences in a vertebra.

FIG. 20 is a schematic diagram illustrating factors affecting cement distribution during a vertebroplasty procedure.

FIG. 21 illustrates steps involved in cement preparation during a vertebroplasty procedure.

FIG. 22 illustrates an ideal needle position for a vertebroplasty procedure.

FIGS. 23A and B illustrate complications which may be simulated during a simulated vertebroplasty procedure.

FIG. 24 illustrates steps of a vertebral venography procedure which may be modeled using a simulation system according to one aspect of the invention.

FIGS. 25A-C illustrate geometric modeling of contours of a body structure to simulate structures which comprise branches and cavities.

### DETAILED DESCRIPTION

The invention provides a system for the simulation of image-guided medical procedures and methods of using the same. The system can be used for training and certification, pre-treatment planning, as well therapeutic device design, development and evaluation.

Definitions

The following definitions are provided for specific terms which are used in the following written description.

As used herein, “a tissue with heterogeneous biomechanical properties” refers to a tissue comprising regions having different resistances against deformation by a medical device. In one aspect, a tissue having heterogeneous biomechanical properties comprises a tissue having at least two different regions identifiable by an imaging process such as CT, MRI, PET, an electron spin resonance technique, and the like.

As used herein, “coupled to” refers to direct or indirect coupling of one element of a system to another. An element may be removably coupled or permanently coupled to another element of the system.

As used herein, “a re-configurable control panel” refers to a display interface comprising one or more selectable options (e.g., in the form of action buttons, radio buttons, check buttons, drop-down menus, and the like) which can be selected by a user and which can direct the system to perform operation(s). Preferably, the one or more options can be selected by touch. The control panel can be modified by a user (e.g., by implementing a system program which alters the display, causing it to display different selectable options) thereby “re-configuring” the control panel.

As used herein, “providing access to a database” refers to providing a selectable option on the display of a user device which, when selected, causes the system to display images or data stored within the database, or causes one or more links to be displayed which, when selected, causes the system to display the images or data. In one aspect, the system displays images or data, or links to images or data, in response to a query of the system by a user. In one aspect, the display interface provides a “query input field” into which the user can input a query and the selectable option is an action button for transmitting the query to the system.

As used herein, the term “in communication with” refers to the ability of a system or component of a system to receive input data from another system or component of a system and to provide an output response in response to the input data. “Output” may be in the form of data or may be in the form of an action taken by the system or component of the system.

As used herein, “deployment of a balloon” refers to either inflation or deflation of the balloon.

As used herein, “a biomechanical property” refers to a property which relates to the structure or anatomy of a tissue or organ which is measurable, generally without the aid of a labeled molecular probe; for example, biomechanical properties of a blood vessel include, but are not limited to: elasticity, thickness, strength of ventricular contractions, vascular resistance, fluid volume, cardiac output, myocardial contractility, and other related parameters.

As used herein, “a volume image” is a stack of two-dimensional (2D) images (e.g., of a tissue or organ) oriented in an axial direction.

As used herein, an “interventional medical device” includes a device for treatment (e.g., needles, stents, stent-grafts, balloons, coils, drug delivery devices), for diagnosis (e.g., imaging probes), and for placement of other medical devices (e.g., guidewires). Some devices, such as catheters, can have multiple functions.

As used herein, a “knowledge base” is a data structure comprising facts and rules relating to a subject; for example, a “vascular properties knowledge base” is a data structure comprising facts relating to properties of blood vessels, such as elasticity, deformation, tissue and cellular properties, blood flow, and the like and rules for correlating facts relating to vascular properties to interactions with one or medical devices.

As used herein, a “rule” in a knowledge base refers to a statement associated with a certainty factor. Rules are generally established by interviewing human experts, performing experiments, by obtaining data from databases or other knowledge bases, and even by obtaining data from the system itself during a simulation.

As used herein, an “expert system” comprises a program for applying the rules of one or more knowledge bases to data provided to, or stored within the knowledge base(s), thereby enabling the knowledge base(s) to be queried and to grow. Preferably, an expert system comprises an inference engine which enables the system to manipulate input data from a user to arrive at one or more possible answers to a question by a user. More preferably, an expert system also comprises a cache or dynamic memory for storing the current state of any active rule along with facts relating to premises on which the rule is based.

As used herein, a system which “simulates a path representing at least a portion of a body cavity or lumen” is a system which displays a three-dimensional representation of the internal surface of the at least a portion of the body cavity or lumen on the interface of a user device in communication with the system.

As used herein, to “determine the best fit between the geometry of the device and the geometry of the path” refers to displaying a representation of at least a portion of the device and simulating its placement within at least a portion of the body cavity or lumen.

As used herein, a “device parameter” refers to a physical property of a device, e.g., such as flexibility, memory, material, shape, and the like.

As used herein, “a physical model of a device” is a combination of a recommended geometrical model, topology, and material. It is also the basis for making the first design of a medical device based on patient-specific data.

As used herein, a “software suite” refers to a plurality of interacting programs for communicating with an operating system.

As used herein, “clinical data” refers to physical, anatomical, and/or physiological data acquired by medical image modalities including, but not limited to X-ray, MRI, CT, PET, ultrasound (US), angiography, video camera, and/or by direct physical and/or electronic and/or optical measurements, and the like.

Simulation System

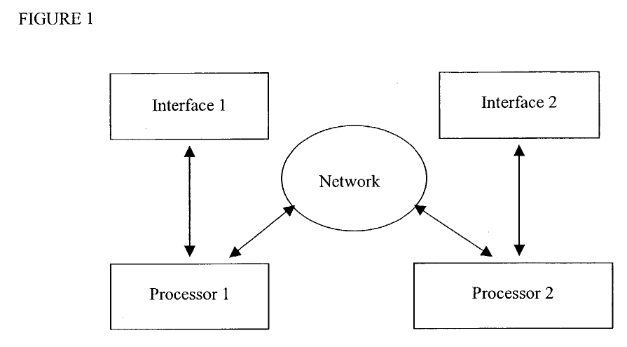

FIG. 1 is a block diagram of a simulation system according to one aspect of the invention. Input into the system executes a particular simulation to be enacted. Generally, a simulation includes images of a patient and also can include a display of patient-specific information (e.g., such as clinical information and medical history). The patient images can be obtained from a database of patient-specific images or images relating to a population of demographically similar patients (e.g., such as patients sharing a pathology). In one aspect, patient-specific images are obtained from a patient to be treated for a condition (such as a pathology). Such images may be stored in the system in a system processor and/or may be obtained in real-time prior to a procedure, i.e., the health care worker may be conducting pre-treatment planning as images are collected from a patient in an operating room or other health care facility.

Preferably, the database additionally contains patient information, e.g., such as data relating to physiological responses of the patient (e.g., body temperature, heart rate, blood pressure, electrical impulses of the brain, conductivity of neurons), data relating to patient medical history, demographic characteristics of the patient (e.g., age, gender, family history, occupation, etc). Preferably, the patient information relates to a patient to be treated and whose images are being displayed. In one aspect, patient information is updated in real time as the image of one or more patient tissues is updated.

The system additionally comprises an information management system. User requests or queries are formatted in an appropriate language understood by the information management system that processes the query to extract the relevant information from the database of patient images and patient data. In one aspect, the system communicates with one or more external databases which provide access to data relating to a patient condition being treated, responses to the same or other treatment regimens, epidemiological data, sources of scientific literature (e.g., PubMed) and the like.

The system generally operates by means of a software suite that operates on a general purpose computer such as a PC or IBM-compatible device. Preferably, the system comprises at least one processor (e.g., as CPU), memory, graphics adaptor, printer controller, hard disk and controller, mouse controller, and the like. The processor should comprise a minimum of about 8 MB of RAM. The software suite of the system comprises a program (e.g., a C language program) that controls the system's user interface and data files, e.g., providing one or more of search functions, computation functions, and relationship-determining functions as part of the information management system for accessing and processing information within the database.

Preferably, the system also accesses data relating to one or more medical devices. For example, the system can include data files relating to the shape and physical properties of one or more medical devices, such devices include but are not limited to: a needle, a catheter, guidewire, endoscope, laparoscope, bronchoscope, stent, coil, balloon, a balloon-inflating device, a surgical tool, a vascular occlusion device, optical probe, a drug delivery device, and combinations thereof. In one preferred aspect, the medical device is a needle which comprises a lumen for injecting materials into and/or removing materials from the body of a patient.

The system is able to model the interactions of multiple devices with each other. For example, the system can model the simultaneous movements of a needle, a catheter, guidewire, therapeutic device, and the like. However, preferably, the system does not merely simulate movement or placement of a device in the body of a patient but simulates interactions of the device with tissues of the body. In one aspect, the system models insertion of a medical device through a tissue, subsequent movement of at least a portion of the device through multiple different types of tissue (e.g., layers of skin, muscle, fat, bone, etc.) and/or empty spaces in between tissue or lumens. Accordingly, the system displays images of tissues having different biomechanical properties and models the interactions of one or more medical devices with the different tissues. Preferably, the system models both biomechanical properties of tissue(s)/organ(s) and physical properties of the medical device being simulated so that interactions between the medical device and tissue(s)/organ(s) reflects changes that may occur in the tissue(s)/organ(s) (e.g., deformation, ablation or removal of cells, fluid flow, etc) as well as changes that may occur in the medical device (e.g., bending, movement of one or more portions of the device, deformation, etc.). In one aspect, the system models movement of tissue(s) and/or organ(s) in response to direct or indirect contact with a medical device (e.g., such as insertion of the medical device into the tissue(s) and/or organ(s) or insertion into neighboring tissue(s) and/or organs).

In another aspect, the system models an operation of the medical device such as injection of a therapeutic agent, removal of a biological material, placement of an implant, transplant, or pacemaker, and/or exposing of one or more tissues to a therapeutic regimen including, but not limited to exposure of a tissue to heat, light, microwave, ultrasound, electroporation, exposure to an electric field, etc. Additionally, the system simulates an effect of the operation on one or more tissues of the body, for example, such introduction of a therapeutic agent into one or more cells of the body, injection of a material, removal of a one or more cells, destruction of one or more cells, permeabilization of one or more cells, and the like.

In one aspect, the system is used to simulate and/or plan a percutaneous procedure. As used herein, a “percutaneous procedure” refers to a procedure which is performed by inserting at least a portion of a medical device into the skin at one or more stages of the procedure. For example, injection of radiopaque material in radiological examination and the removal of tissue for biopsy accomplished by a needle are percutaneous procedures.

The output data resulting from a simulation (e.g., a volume rendered image of at least one tissue of a patient's body as it interacts, preferably, in real time, with a medical device) can be displayed on any graphical display interface on a user device connectable to a system processor (e.g., a digital computer) or a server to which such a computer is connected (e.g., through the internet). Suitable system processors include micro, mini, or large computers using any standard or specialized operating system such as a Unix, Windows™ or Linux™ based operating system. System processors may be remote from where patient data is collected. The graphical interface also may be remote from one or more system processors, for example, the graphical interface may be part of a wireless device connectable to the network.

Accordingly, in one preferred aspect, the system is connectable to a network to which a network server and one or more clients are connected. The Network may be a local area network (LAN) or a wide area network (WAN), as is known in the art. Preferably, the network server includes the hardware necessary for running computer program products (e.g., software) to access database data for processing user requests.

The system also includes an operating system (e.g., UNIX or Linux) for executing instructions from a database management system. In one aspect, the operating system also runs a World Wide Web application, and a World Wide Web server, thereby connecting the server to a network.

Preferably, the system includes one or more user devices that comprises a graphical display interface comprising interface elements such as buttons, pull down menus, scroll bars, fields for entering text, and the like as are routinely found in graphical user interfaces known in the art. Requests entered on a user interface are transmitted to an application program in the system (such as a Web application) for formatting to search for relevant information in one or more of the system databases. Requests or queries entered by a user may be constructed in any suitable database language (e.g., Sybase or Oracle SQL). In one embodiment, a user of user device in the system is able to directly access data using an HTML interface provided by Web browsers and Web server of the system. Preferably, the graphical display interface is part of a monitor which is connected to a keyboard, mouse, and, optionally, printer and/or scanning device.

In one aspect, the system provides a web-based platform enabling one or more aspects of the simulation to be performed remotely. For example, the interface with haptic feedback controls may be in a different location from a computer memory comprising the system database; and/or from a patient from whom patient specific information is being collected. Such a web-based platform also facilitates the use of the system by multiple users, for example, allowing an expert to provide input into pre-treatment planning and/or training and/or to modify a simulation.

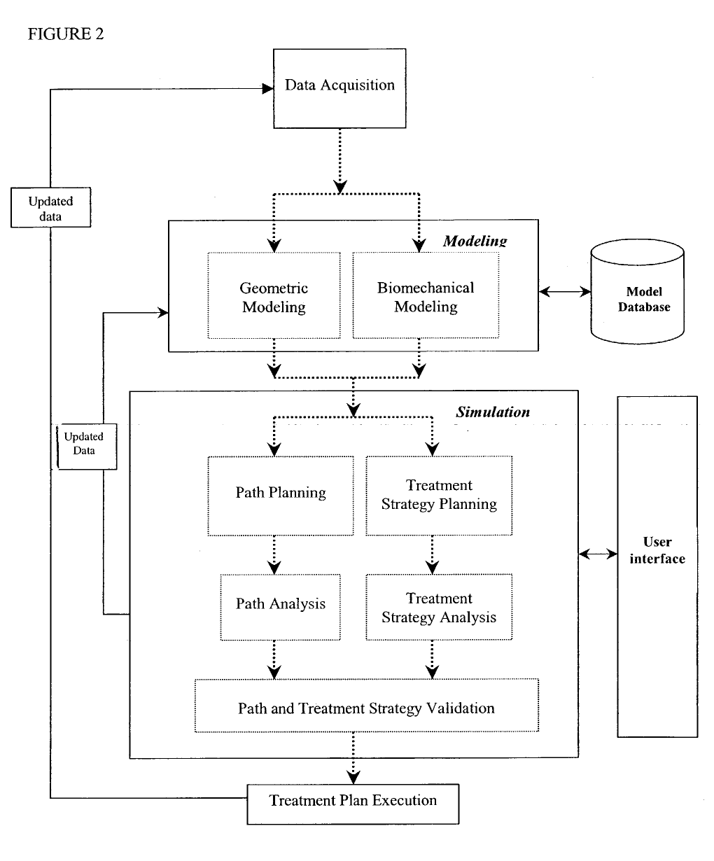

As shown in FIG. 2, preferably, the system implements a program provided in a computer readable medium (either as software or as part of an application embodied in the memory of a system processor) which comprises computer program code for identifying an interface in communication with a processor which is capable of simulating contact between a user and the medical device. The computer readable medium further comprises program code for running an application comprising instructions for simulating the operation of a medical device in communication with the interface on at least one tissue and/or organ in the body of a patient.

The simulation process as illustrated in FIG. 2, comprises a step of data acquisition in which the system acquires a dataset for generating a volume-rendered image of at least a portion of a patient's anatomy. The dataset can be obtained from any of a number of imaging modalities currently used in image-based medical procedures, e.g., x-ray, CT, MRI, MRA, PET, electron spin resonance, etc. However, the data used to produce the image may also be obtained from modalities not used to generate an image or which do not display an image at the time data is provided to the system, i.e., data relating to light and/or heat emitted by a tissue and/or magnetic properties of a tissue, and/or the behavior of biomolecules in a tissue may provide data for generating a volume rendered image. Data also may be obtained from combinations of data acquisition modalities.

For the purpose of training, the dataset can be obtained from the various kinds of models, manikins, phantoms, or from one or more human patients. For the case of pretreatment planning, the dataset preferably is acquired from a patient to be treated. Through observing interactively rendered fluoroscopic images on the graphical display interface, the site of the pathology and a proposed treatment strategy are determined.

In one aspect, data (such as optical data) relating to one or more tissues, body cavities, and/or lumens are obtained and provided to the intervention simulation system. The data can be displayed directly on one or more user interfaces or can be stored in a system database as described above. Because the system user devices and processors are connectable to the network, patient data also can be accessed from remote databases.

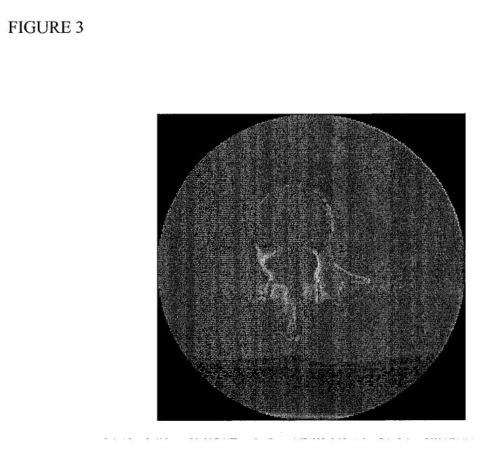

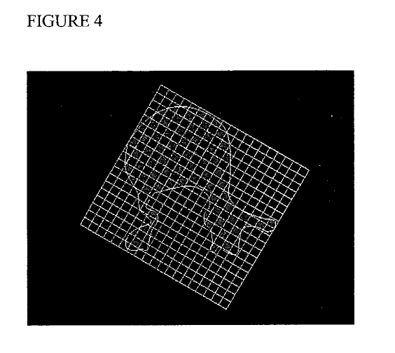

In creating a geometric model, a user of the system performs image processing tasks on a plurality of scanned images to create geometrical structures and a topology which corresponds to the contours of a body cavity or lumen belonging to a patient being analyzed. To generate a volume-image, a stack of two-dimensional (2D) images is collected by a scanning device in an axial direction and is used to form a three-dimensional (3D) structure (see, e.g., as shown in FIGS. 3A and 3B). Almost all medical scanners can produce these axial images or can produce images that can be converted easily to axial images. Suitable scanning devices include, but are not limited to, x-ray devices, magnetic resonance imaging (MRI) devices, ultrasound (US) devices, computerized tomography (CT) devices, rotational angiography devices, gadolinium-enhanced MR angiograph devices (MRA), or other imaging modalities (e.g., such as PET, SPECT, 3D-US). For example, rotational CT scanners capture patient data in the form of projection images. By using a Filtered Back Projection technique or Arithmetic Reconstruction Technique (ART), volumetric images can be constructed.

Three-dimensional (3D) geometrical and biomechanical models of a target area (e.g., a site of a pathology, injury, wound, lesion, etc.) are built from the image dataset. Such a task can be implemented automatically or interactively.

Geometric models may be generated using volume rendering techniques such as ray casting and projection techniques have traditionally been used in the visualization of volume images. Ray casting methods shoot rays through a volume object from each pixel in an image and employ algorithms that trilinearly interpolates samples along each ray, providing complex shading calculations and color assignments at the sample points which are then accumulated into final pixel colors (see, e.g., Kaufman, In Volume Rendering, IEEE Computer Science Press, Las Alamitos, CA, 1990). Real-time volume rendering with hardware texture mapping (e.g., SGI) for UNIX platform or with board card (e.g., Mitsubishi VolumePro) for PC platforms are commercially available.

The simulation system may be connected to the output of one or more scanning devices, e.g., collecting data for generating images from such devices as these are acquired. However, in another aspect, the system may include a means for extracting features from individual scanned images (e.g., communicated to the system through a scanner, or provided as an image file, such as a pdf file) to construct a 3D volume image. The geometric modeling arm of the system can be implemented remotely by a user to determine one or more of: the geometry/topology of one or more tissues, measurements relating to any pathological features of the one or more tissues.

Commercially available image processing tools, such as Photoshop™ can be used to manually draw out the shape of the structure from each scanned image. Various imaging-processing tasks, as are known in the art, can be performed by the system; for example, segmentation can be used. Several improved algorithms using iso-surfacing or volume-rendering techniques to visualize vascular trees also can be used and have been described in Ehricke, et al., Computer & Graphics 18(3): 395-406, 1994; Cline, et al., In Magnetic Resonance Imaging (Pergamon Press) 7: 45-54, 1989; and Puig, et al., Proc. Of Visualization '97, pp 443-446, for example.

A biomechanical model is generated by dividing an image set into voxels, each voxel a unit of graphic information that defines a point in three-dimensional space, and defining biomechanical properties for each voxel. The biomechanical properties defined for each voxel include tissue type (e.g., skin, fat, muscle, bone, etc); tissue subtype (e.g., dermis or epidermis for skin, compact and/or trabecular bone or cancellous bone for bone); and biomechanical parameters for these tissue types/subtypes. Such parameters are employed in calculation by the system to simulate interactions between at least one tissue or organ and a medical device, e.g., to calculate deformation, amounts and duration of force feedback and other simulation-related data.

Biomechanical properties can be determined by a number of suitable assays, singly or in combination. For example, ultrasound may be used as described in Krouskop, et al., J Rehabil. Res. Dev. 24(2): 1-8, 1987; Clark, et al., J. Biomed. Eng. 11(3): 200-2, 1989; Ophir, et al., Ultrason. Imaging 13(2): 111-34, 1991; and Zheng and Mak, IEEE Trans Biomed 43(9):912-7, 1996, to determine biomechanical properties of soft tissues and to model blood flow. Stress strain curves for tissues may be derived and used to calculate modulus, ultimate tensile strength, ultimate strain and strain energy density, as described in France, et al., J. Biomechanics 16: 553-564, 1983; Fujie, et al., J. Biomech. Engng. 115, 211-217, 1993, for example. Viscoelastic properties may be measured by elastography (optical, MRI-based, etc.). Biomechanical properties of bone may be determined by compression testing (e.g., to calculate maximum load, compressive strength, elastic modulus and energy). Additionally, myotonography may be used to measure biomechanical properties of muscle (see, e.g., Eur. Arch. Otorhinolaryngol. 259(2): 108-12, 2002). Stress-relaxation assays may be used to measure biomechanical properties of skin (see, e.g., Plast. Reconstr. Surg. 110(2): 590-8, 2002).

In one aspect, biomechanical models are derived from healthy patients. However, in another aspect, biomechanical models are derived from patients having a condition such as a pathology, injury, or wound. For example, biomechanical models may be used to simulate abnormalities of the heart (see, e.g., Papdemetris, et al., IEEE Trans. Med. Imaging 21(7): 786); spinal cord injuries (Stokes, et al., Spinal Cord 40(3): 101-9, 2002); skin disorders (Balbir-Gurman, et al., Ann. Rheum. Dis. 61(3):237-41, 2002; Seyer-Hansen, et al., Eur. Surg. Res. 25(3):162-8, 1993), bone fractures, Med. Biol. Eng. Comput. 40(1): 14-21, 2002, the effect of tumor growth (Yao, et al., J Biomech 35(12): 1659-63, 2002; Kurth, et al., Skeletal Radiol. 30(2):94-8; Kyriacou, et al., IEEE Trans Med Imaging 18(7): 580-92); interactions between a tissue and an implant or a graft, and the like. In one aspect, the system provides a database of biomechanical models correlated with one or more patient characteristics, such as pathology, injury, age, gender, weight, cholesterol levels, HLA haplotypes, and the like.

The geometrical and biomechanical models are loaded and registered to a virtual human body that is displayed on a graphical user interface of the system. The models may be stored, generated from stored image datasets, or generated from newly obtained datasets. In one aspect, image data sets are collected as the simulation is taking place and models are updated at intervals (e.g., at least once every 5 minutes, preferably, at least once every minute, more preferably, at least once every 30 seconds). In another aspect, the display module of the system including the graphical user interface displays images with a refresh rate of about 15 frames per second.

In one preferred aspect, the system generates the geometric model and biomechanical model are combined to obtain a virtual image of one or more tissues using a finite element analysis program, e.g., such as ABAQUS (Hibbit, Karlsson & Sorensen, Inc.) to produce a 3D volumetric finite element mesh. This process can be subdivided into steps of: (1) manual segmentation of contours, (2) multiple resolution 2D meshing and (3) 3D meshing.

Step 1 is illustrated in FIG. 3, which exemplifies the modelling process for the spinal column and surrounding soft tissues. In one preferred aspect, manual segmentation is used to outline portions of one or more tissues to enhance contrast between adjacent tissues and/or between portions of a single tissue with heterogeneous biomechanical properties. Manual segmentation may be performed using a commercial image-processing program, AdobePhotoshop®, USA.

Typically, the naming of contours used in segmentation is used solely for identification of anatomy and/or changes in material properties of the tissue group being segmented. In this invention, a specific segmentation nomenclature has been developed in order that the software program of the system may determine the 3D connectivity of complex biological structures and automatically assemble the 3D volume and resultant meshes.

The cervical vertebrae and intervertebral discs shown in FIG. 3 provide an example of application of this nomenclature. Convex and concave surfaces are modelled as well as branches, shells, and holes forming in various parts of the anatomy. This technique is also applicable to other problems such as bifurcation of blood vessels, even when these vessels are modelled as hollow tubes.

In the aspect shown in FIG. 3, manual segmentation was performed in Adobe Photoshop. The naming of the contours is the name given to the “path” in Photoshop. Each contour has its own contour name, where the nomenclature is:

Contour Name=[ObjectName]−[TissueName].[ConnectivityStr]

For example, C3˜Body.1 is the body of the third cervical vertebrae. The tilde, period, and comma are used to differentiate different parts of the contour name. All contours with the same Object Name are used to form a single object. Different connectivity strings specify the 3D connectivity.

Possible connectivity scenarios are: branch formation, cavity formation, and branching of cavities.

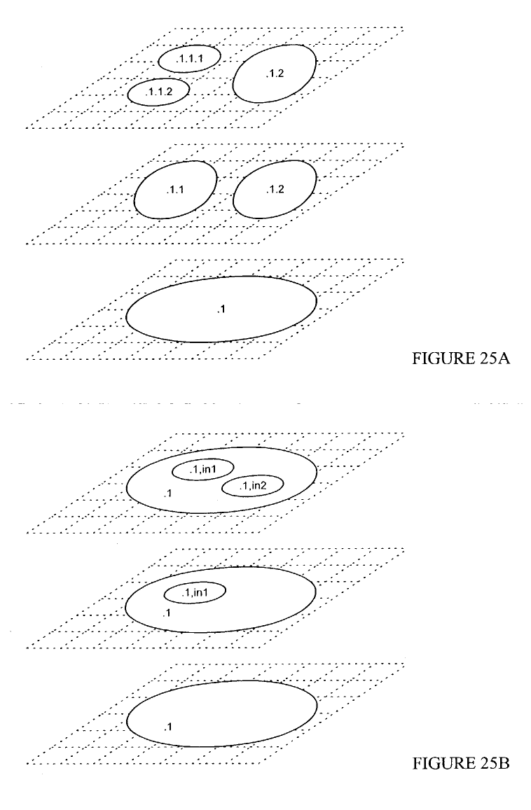

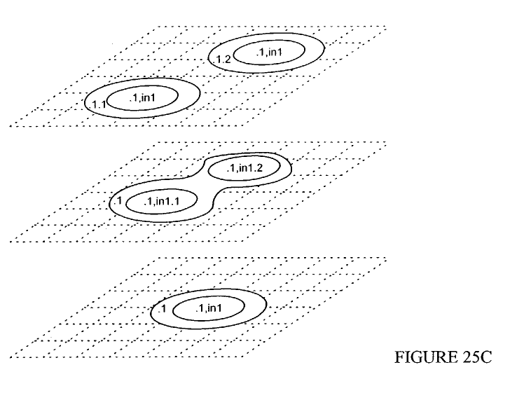

When a branch forms, segmentation progresses from one contour in the first slice to two separate contours in the second slice. This is denoted by the first slice have a ConnectivityStr=1 and the second slice having ConnectivityStr=1.1 and ConnectivityStr=1.2. Subsequent branching appends further connectivity numbers to create 1.1 and 1.1.2 and so on. This process is illustrated in FIG. 25A.

When a cavity forms, segmentation progresses from one contour in the first slice to two contours in the second slice, with one being inside the other. This is denoted by the first slice's contour having ConnectivityStr=1 and the second slice having outer contour ConnectivityStr=1 and inner contour ConnectivityStr=1,in1 Further cavity formation is denoted as 0.1,in2 and 0.1,in3 etc. where these cavities are completely separate from each other. See, as shown in FIG. 25B.

Branching of cavities occurs in vasculature when the hollow tube bifurcates. The nomenclature progresses logically, but instead of a separate cavity forming as in 0.1,in1 and 0.1,in2 the cavity branches, progressing from 0.1,in1 to 0.1,in1.1 and 0.1,in1.2 Further branches are named in the same manner. See FIG. 25C.

Using combinations of these simplified scenarios, the complex structure of the third cervical vertebrae with the body, arch, endplates, facet joints, and transverse and posterior processes were reconstructed as shown in FIG. 3.

Multiple resolution 2D meshing is implemented by subdividing the segmented contours into discrete elements using a grid plane approach as shown in FIG. 4.

Meshes generated using this approach have been found to be more suitable for FEM analysis. See, Robert Schneiders (1996), In Grid-Based Algorithm for the Generation of Hexahedral Element Meshes', Engineering With Computers, Vol. 12, 168-177. In one aspect, for every 2D slice of a 3D object (e.g., tissue, organ, medical device), contours of interest are subdivided with a flexible resolution grid or variable resolution grid into a plurality of elements. The flexible resolution grid allows users to increase or decrease mesh density as desired and has intervals that are adjustable by a user of the system to determine element size.

In one aspect, a 2D mesh is generated using a two-dimensional marching cube algorithm. This 2D mesh consists of regular quadrilateral elements as the core and triangular elements are found at the boundaries. The nodes (corners of the elements) and elements are numbered to construct an FEM mesh system for analysis. FIG. 4 exemplifies this process for the L3 vertebral body.

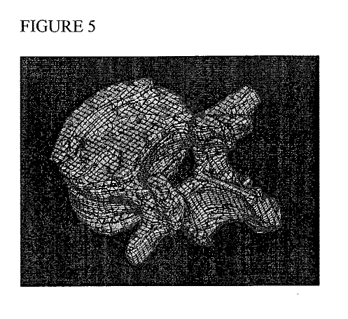

For generating 3D volumetric mesh models, 2D planar meshes of adjacent image slices are joined together as shown in FIG. 5. A 3D-grid frame structure establishes the topological relation of any two adjacent grid planes. The grid frame approach depicts the geometrical closeness of the contours at the adjacent slices, provides an accurate and convenient means to identify the topological connection of the anatomical contours, and builds the planar meshes into volumetric elements. The 3D meshes are therefore built upon the grid frame by connecting corresponding nodes at adjacent grid planes. The system executes a linear interpolation to connect two grid points at adjacent slices having at least one of them at the contour. The definition of point P(k+1) to which P(i,j,k) at the contour of neighboring slice connects is

P(k+1)=P(i,j,k)+α·(P(i+n, j+m,k+1)−P(i,j,k+1)

Where P(i+n,j+m, k+1) is also a contour point locating at the extension of the original to P(i,j, k+1). The coefficient α allows the user to select an appropriate path for the boundary connection, which will affect the results of standard FEM elements generation at the boundary.

a should satisfy the condition:

d/h≦α≦1

where h is the height between two adjacent slices, and d is the distance between the two points P(i+n, j+m, k+1) and P(i, j, k+1). The generated meshes are formed using hexahedral elements (FIG. 5).

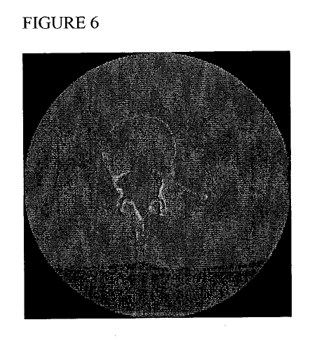

A whole domain defined by contour lines (for example, as shown in FIG. 3) is subdivided into a subdomain that is segmented (see, e.g., FIG. 6). In one aspect, the subdomain comprises a portion of the whole domain (target region) which has different biomechanical properties from other portions of the whole domain. For example, bone (such as a vertebral body) may be subdivided into subdomains of cancellous and trabecular tissue (FIG. 6). Subdomain segmentation comprises obtaining contour data such as coordinate values of the vertices of the contours of the subdomain.

These contours are used to determine if each node of the whole domain's mesh falls within a subdomain or not. To do this the system implements an “inside-outside test”, receiving the coordinates of the nodes and the vertices of the contours as inputs and providing output in the form of a determination as to whether or not the node lies inside or outside of the region defined by the contour vertices of the subdomain. In one aspect, the number of nodes per element which lie within the sub domain are determined. In another aspect, the number of element faces that lie within the sub domain are tested. The former method generally yields more accurate results.

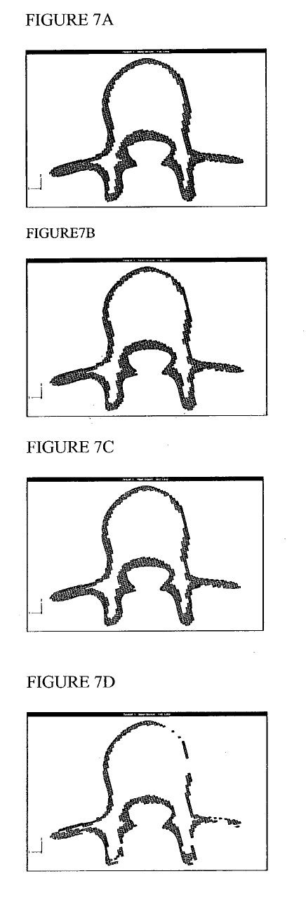

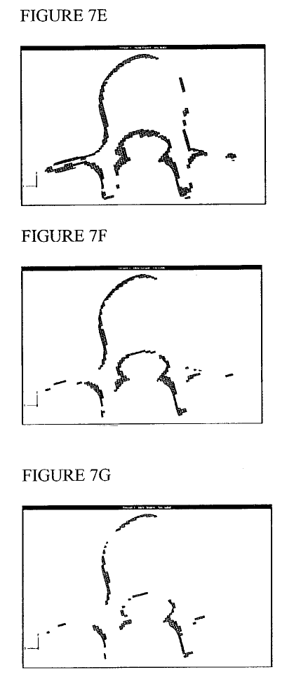

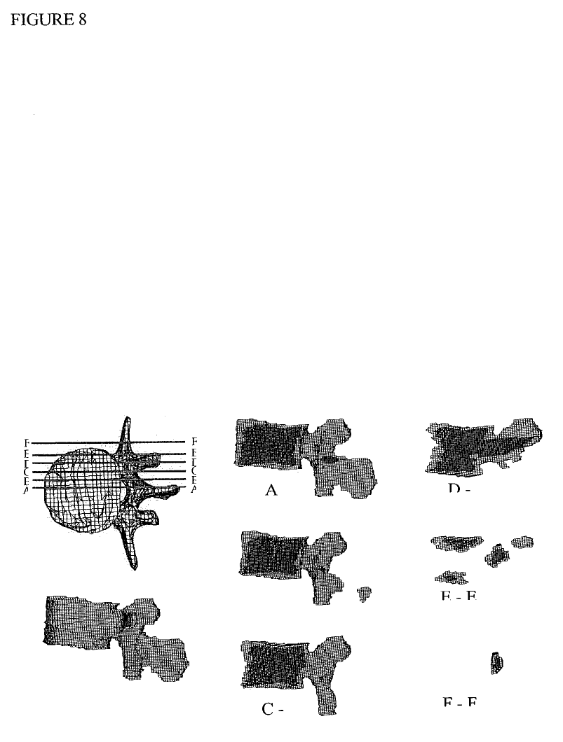

Generally, specifying the number of nodes that are to be within the sub domain before the elements can be classified can vary accuracy. This is shown in FIGS. 7A-G which illustrates increasing accuracy in each panel with FIG. 7G representing 100% accuracy, meaning all 8 nodes of the hexahedral formed from two joined adjacent quadrilateral elements are to be within the sub domain region before classification can be done. FIG. 7A represents 12.5% accuracy, with only one node needed to be in the subdomain before the element is classified as within the subdomain. The two classification sets of the elements, those inside the subdomain and those outside the subdomain, are specified according to their biomechanical properties and FE analysis is performed while maintaining FE model connectivity (FIG. 8).

Unlike prior art methods, this connectivity is not compromised and there are no interfacing problems resulting from generating separate FE models of different tissues and/or for different areas of a single tissue.

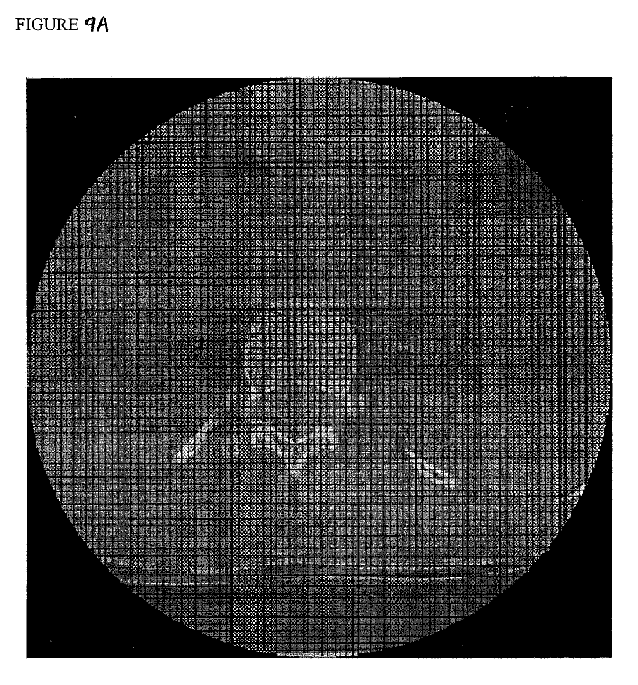

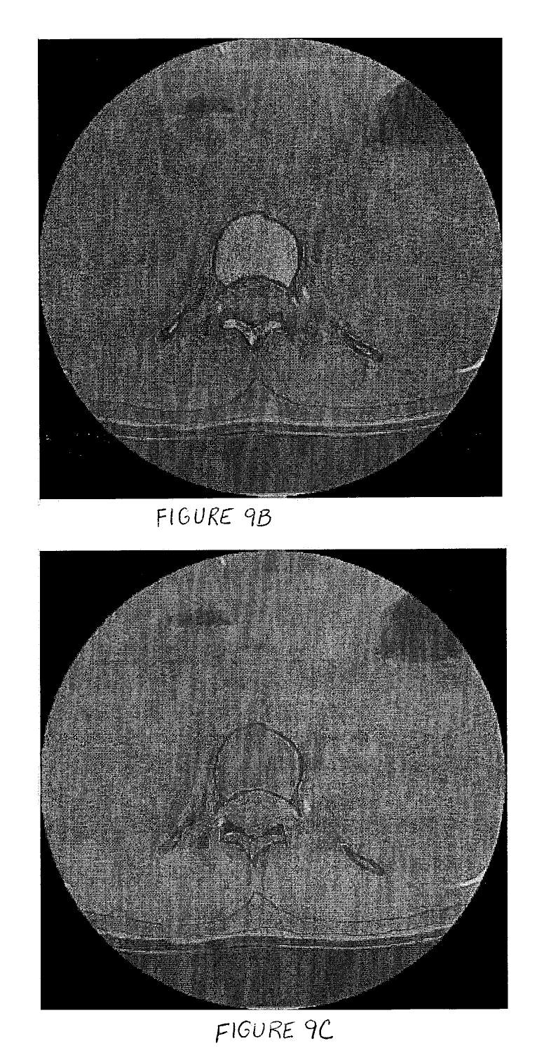

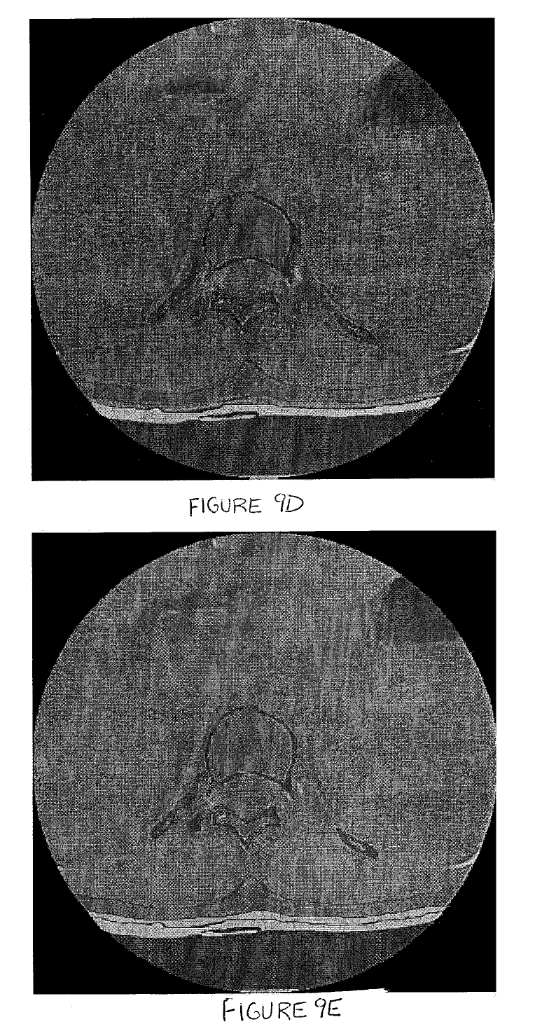

FIG. 9A shows the meshing of an entire domain comprising a target region being simulated. Subsequently, subdomain boundaries are meshed (e.g., soft and hard tissue boundaries, such as for cortical bone, cancellous bone, skin, fat, muscle, etc.). In certain aspects, tissue and fluid boundaries (e.g., such as blood) are meshed. See,

FIGS. 9B-E. Using the inside-outside test method, these subdomains of interests are differentiated, thus providing a complete model as shown in FIGS. 9F and G. FIGS. 9F and G show the method used in an iterative fashion for the differentiation of the subdomains. FIG. 9G graphically shows the elements (dark grey) which represent the cortical bone after the first iteration of the inside-outside test. FIG. 9G shows the elements which represent the cancellous bone (brown) as well. After a plurality of reiterations, subdomain regions of interest within the entire domain (i.e., a region being simulated) are differentiated. The elements differentiated into each subdomain set can be assigned material properties that best approximate properties of actual tissue (e.g., biomechanical properties) know or newly determined.

A simulation of a medical device can be obtained from a database of images of stored devices (e.g., where these are known and/or commercially available) or from a simulation of a device, for example, as described in U.S. Provisional Application Serial No. 60/273,734, filed Mar. 6, 2001. A volume-scanned image of the device also can be generated using techniques similar to those described above.

Preferably, a physical model is used to simulate a device based on the quantitative analysis of volume-rendered images, followed by a derivation of the geometry, topology, and physical properties of the device. Suitable medical devices which can be simulated include, but are not limited to: a needle, trocar, a catheter, guidewire, endoscope, laparoscope, bronchoscope, stent, coil, balloon, a balloon-inflating device, a surgical tool, a probe, a vascular occlusion device, a drug delivery device, and combinations thereof. The system is able to model the interactions of multiple devices with each other or moveable portions of a device with other stationary or movable portions of the device.

The user can manipulate the medical device manually or through the computer with reference to the images displayed on the graphical user interface. When the medical device is in a desired position and orientation outside the virtual human body relative to a target tissue to be diagnosed and/or treated, the user can advance it to “insert” it into the virtual human. The position of the medical device is detected (preferably through continuous tracking via encoders and detectors which are part of the medical device interface) and displayed, preferably in real-time.

Real-time interaction is an important feature of the instant invention. The immersion of a user, and therefore, his or her ability to learn from the simulation system, is directly linked to the bandwidth of various components of the simulation system. An acceptable bandwidth for visual display is in the range of about 20-60 Hz while an acceptable bandwidth for haptic display is in the range of about 300-1000 Hz (where 300 Hz is the free hand gesture frequency). Two parameters that are particularly important for accurate perception by a user are latency and computation time. Latency measures the time between sensor acquisition (e.g., acquiring the position of a simulated medical device) and system action (e.g., haptic rendering or force feedback). Computation time is that amount of time needed to determine the equilibrium state of a structure (e.g., a representation of a device and cavity/lumen) and to update the resulting models. There are several contributing causes of latency, including, but not limited to: time required for communication between input devices and the system processor, time for communication between the haptic display and the system processor, time for communication between the visual display (e.g., the 2D display) and the processor, time to compute collision detection, time for force feedback, and time for computing deformation models. Latency depends greatly on hardware and preferably the system comprises an at least about 16-bits bus for internal transmission within the embedded system (e.g., manikin interface), and a combination of serial and USB transmissions to create external links between simulated devices and the system processor. Realism is also important. Very often, real-time interaction and realism are correlated. Preferably, the simulation system according to the invention provides a visual feedback of 12-15 frames per second.

In certain cases, the graphical user interface displays a reconfigurable control panel for controlling one or more operations of the medical device (e.g., balloon deployment, injection, etc) necessary for performing a required procedure. When a medical device is selected for simulation, an image of the device is shown in the virtual space at a default location outside the virtual human body. Preferably, as part of this process, the system also builds geometrical and physical models of the medical device for simulating deformation of at least a portion of the device, e.g., bending, flexing, movement of one part of device relative to another, interactions with fluids in the device (e.g., such as materials to be injected into a patient) and/or in the portion of the patient's anatomy being simulated (e.g., blood, lymph), and the like.

The interactions between the medical device and one or more tissues are calculated and the amount of force feedback required to effect a realistic simulation is calculated and applied through haptic feedback mechanisms in the medical device interface (discussed further below). Feedback forces are calculated based on the biomechanical properties of tissues which the device comes into contact with during the simulation and preferably, also on the physical properties of the device.

If the medical device is in the targeted position, further operations can be carried out including, but not limited to: injection (e.g., of contrast medium, cement, a solution comprising a therapeutic agent); removal (e.g., of fluid, cell(s), tissue(s); organ(s)); tissue dissection; incision; pinching; suturing; application of heat, light, ultrasound, an electric field, microwaves, x-ray; implantation; grafting; transplantation; reconstruction; etc., deployment of a device (e.g., balloon inflation, etc.) can be carried out. In such processes, the user can obtain a realistic hand-eye coordinated experience of the procedure and can evaluate the path and treatment strategy to be implemented.

In one aspect, the physical properties of a material being injected is used to calculate and model changes of one or more tissues in response to contact with the material. For example, the hydrodynamic effects of fluid flow and/or the therapeutic range of an agent (e.g., the ability of an agent to diffuse from a delivery site) may be calculated to model effects on the one or more tissues. In one aspect, delivery of a labeled therapeutic agent (e.g., such as a labeled nucleic acid) and its introduction into one or more cells at a target site is simulated. In another aspect, the system models the movement of tissue(s) and/or organs upon direct or indirect interaction with a medical device, such as insertion of a medical device into the tissue(s) and/or organ(s) or insertion into neighboring tissue(s) and/or organ(s).

The system may calculate optimal paths for a medical device during a procedure for pre-treatment planning and may do so automatically, with user input, or by a combination of such methods. In one aspect, once an optimal pretreatment plan is obtained, the system may communicate with a robotic instrument for automatically implementing the procedure in a patient. In another aspect, a user of the device continues to receive haptic feedback relating to the implementation of the procedure on a patient through the robotic instrument so that the user can modify the procedure as necessary in real-time.

As shown in FIG. 2, data may be obtained from various modules of the system and fed back to other modules of the system. For example, data obtained from the the simulation module of the system may be received by the modeling module to modify an image presented. Thus in one aspect, data from a simulation in which a user of the system damages a tissue is received by the modeling module and the modeling module then executes modeling of the damaged tissue. Data received from pretreatment planning may also be fed back to a data acquisition system, e.g., triggering the system to update image information and/or to the modeling module. Data received from actual treatment of a patient (data validation) also maybe fed back to the system to trigger new image data acquisition and a new simulation (i.e., allowing a treatment method on a patient to be simulated while the patient is actually being treated, to enable a user to evaluate the possible outcomes of modifications to the treatment as the treatment is ongoing).

Workstations and Medical Device Interfaces

The medical device is generally coupled with or an integral part of a medical device interface of the system. In one aspect, the interface is encased in a housing comprising one or more openings for receiving medical devices, and means for interfacing with tracking unit(s), feedback mechanism(s) and a system processor. Additional devices such as syringes and balloon inflating devices can be provided as part of the interface, e.g., simulating balloon angioplasty proceedings). The housing may be coupled to a model of a patient's anatomy, e.g., a manikin in which case the interface housing can be displaceable for some distance from the manikin itself or can project from the manikin (e.g., being an integral part of the manikin). To further enhance realism, only the opening(s) of the housing may visible from the manikin (e.g., the interface “housing” can be part of the manikin). In one aspect, the interface is an embedded system, with openings into areas of the manikin simulating areas of medical intervention.

One or more monitors can be used to display simulated images simulating the internal anatomy of a patient. In one aspect, 2-D fluoroscopic views are displayed at the same time that 3D geometric models are displayed by system graphical user interfaces. Preferably, the user has the option to adjust fluoroscopic images by one or more of zooming, collimation, rotation, and the like. In combination with 3D volume-rendered images generated using display interfaces described further below, a user can view the anatomy of a patient from various positions or angles along x-, y-, and x-axes. This option can be of major value in pre-treatment planning, since a physician can use the system to evaluate different treatment approaches prior to performing actual intervention in a patient.

One or more simulated scanning devices additionally can be provided, e.g., in the form of a mock C-arm equipped with an x-ray emitter. In one aspect, the mock C-arm can move along the long side of an operating table on which the patient/manikin is placed and can rotate around the table to simulate capturing a patient's images at various lateral and angular positions.

Peripheral instruments also may be provided to enhance the realism of the simulation. For example, footswitches can be used to simulate activation of a simulated x-ray device as well as image acquisition and storage. In response to this activation, one or more monitors simulate fluoroscopic images obtained. A footswitch is preferred for scanning and image processing, since user(s) generally have their hands occupied with other equipment, in actual practice. Preferably, the system provides a re-configurable control panel (e.g., a touch screen) to enable a user to simulate interface manipulation, image acquisition selection and display, and the use of shutter devices to limit the extent of the field of view provided by a scanning device. The panel also can be used to implement the various operations of a medical device discussed above. Preferably, the graphical user display is programmable and has a large storage area for bitmaps, display lists, and screens. Users can easily set up complex image control panels according to their own requirements.

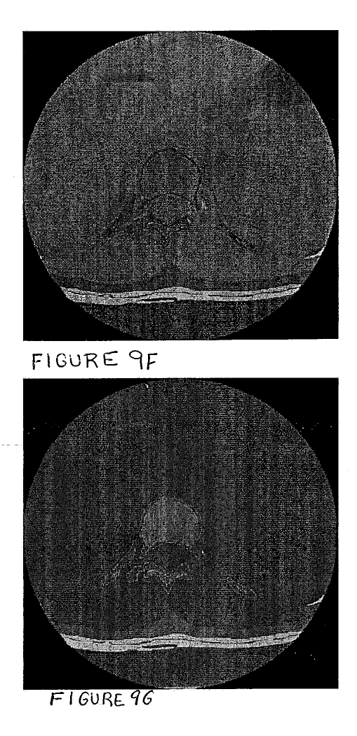

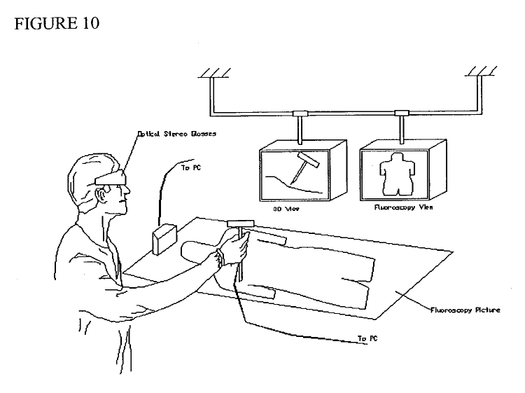

FIG. 10 illustrates one embodiment of a workstation for performing simulations according to the invention.

The simulation system workstation comprises a PC with dual monitors, a surgical table and other tracking/haptic devices. A 3D virtual patient is modeled and data relating to the patient stored in the computer and is visible to the user through the optical stereo glasses. In this dual monitor system, one monitor is dedicated to simulate fluoroscopic image at user-defined angle of projection. The other is used to show other auxiliary views such as three-dimensional model of the operating region, cross-sectional planar view and/or roadmaps. The tracking devices can be developed from commercially available phantom, robot arm or other 3D locating devices.

In order to achieve more realistic hand-eye coordination, the invention further provides several optional configurations for haptic device.

Tracking and Force Feedback Mechanisms

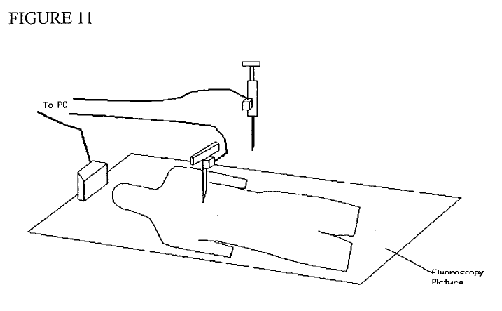

FIG. 11 shows an embodiment for tracking needles (including syringes) during a medical procedure, such as vertebroplasty, needle biopsy, etc but is generally applicable to any type of medical device and/or medical procedure.

The workstation in this embodiment comprises a 3D position sensor to track the location (x, y, z, coordinates) of the needles in real time. Such information is used to determine the spatial relationship between the needle and the virtual human body. The user can move these devices in the virtual space to the desired location. Subsequently, the needle is inserted to the virtual human body. The needle is registered in the virtual patient and displayed in 3D space and the simulated fluoroscopic images. After the tip of needle is in the desired location, the syringe is inserted to the virtual patient as would be done in a real procedure. Subsequent processes such as injection or removal of material from a patient (e.g., tissue extraction) can be performed through the syringe. In the present implementation, liquid can be injected to or extracted from the tissue through pushing/pulling of the inner handle of syringe. The simulated syringe can detect the volume value and rate of injection/extraction in real time. This information is communicated to the computer to calculate the results of such manipulations and to simulate the effects of such results on the virtual human body.

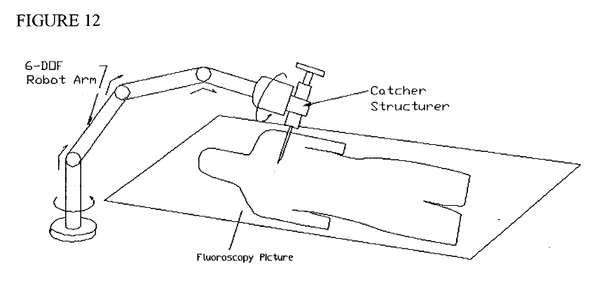

In a different embodiment as shown in FIG. 12, a robot arm with six degrees of freedom is used to perform precise operation involving a needle placement. The user manipulates the devices as in the actual procedure. However, these devices are also held onto by a robotic arm that is control by a system processor. The robotic arm reacts to user's manipulation, providing resistance force feedback and slight vibration in accordance with the simulation program. The x, y, z coordinates of the needle is registered in the virtual space and displayed in the monitors.

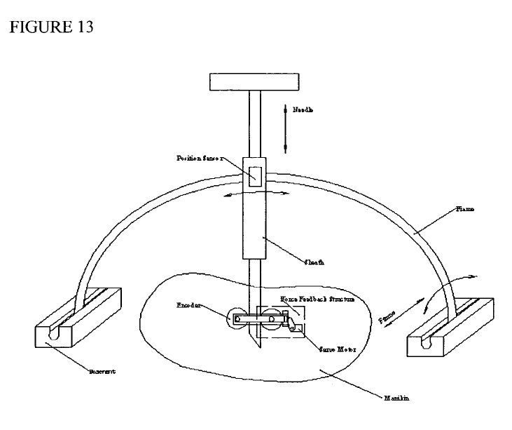

In another aspect as shown in FIG. 13, a system workstation according to the invention comprises a medical device interface comprising a needle coupled to a curved frame. The needle is inserted into a sheath which simulates a syringe barrel and which comprises a lumen. A syringe handle slideably fits within the lumen of the syringe allowing a user to simulate an injection procedure. In this interface, the position (x, y, z, coordinates) of the needle is detected through an encoder and the positioning sensor which can slide along the curved frame. Each end of the curved frame is placed in a channel of a support which it can slide along in and rotate.

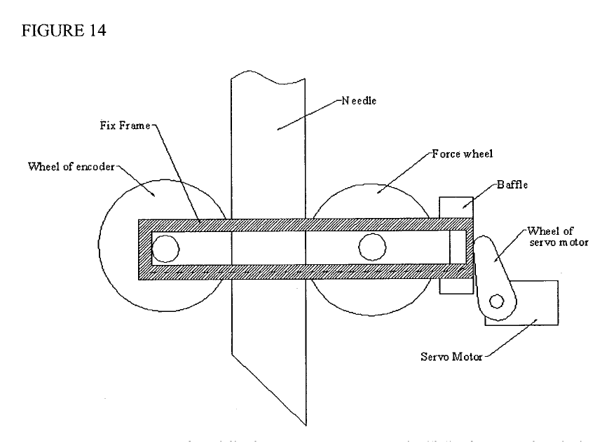

FIG. 14, shows an enlarged view of the needle portion of the device and its interaction with encoders of the interface which allow the position of the needle to be continuously tracked. A force wheel in proximity to the needle implements haptic feedback in response to signals received by a system processor. As the needle advances from virtual skin to a site of pathology in the virtual body of a patient, the resistance forces are calculated from data in the system database concerning the physical properties of the tissue around the needle. Such forces are encoded and transferred to the servo motor that controls the friction resistance between the force wheel and the needle. In this way, a user who is pushing or pulling the needle can experience a resistance similar to that felt during a real procedure. The device is manipulated manually and therefore can provide a realistic hand-eye coordinated experience of the procedure.

If a syringe is involved in the simulation, another set of tracking and force feedback mechanisms is embedded in the simulated syringe. The simulated syringe can detect the volume and volume rate of fluid it is injecting into tissue, and will provide resistance corresponded to such a manipulation. Such a feedback mechanism is described in U.S. patent application Ser. No. 10/091,742, filed Mar. 5, 2002. In the simulated syringe, a servo motor and two arms comprising rubber pads are installed in front of a handspike. These two arms are connected through two meshed gears. Gear1 is installed on a servo motor. So it is a driver. When a force feedback signal is received by the servo motor, Gear1 will contra-rotate and the Gear2 will rotate clockwise. Arm1 and Arm2 will splay and the rubber pads that pasted on the two arms will touch the wall of the syringe. Because of the ensuing friction, the surgeon will feel the resistance when he tries to push or pull the handspike. The degree of friction experienced can be adjusted by controlling the rotation angle of the servo motor. Then if the servo motor rotates in clockwise, the two arms will close and the user can move the handspike freely again.

Control parameters such as injection volume and rate can be controlled by a user through a control interface such as a touch screen, enabling a user to choose the rate and total volume of injection. The injection process can be captured, and selected images of the process saved, to provide an image on a separate monitor.

The simulation workstation can obtain input of various types from one or more system processors to more closely mimic an intervention procedure. For example, input to the simulator can consist of patient medical history and diagnostic data including, but not limited to, data obtained from X-ray, MRI, MRA, CT, PET, images derived from electron spin resonance data or ultrasound images. Data can relate to a specific patient, e.g., where a user is training to perform a procedure on a specific patient and/or is planning a treatment. Alternatively, data can relate to a “symbolic patient”, for example, representing a particular demographic group of closely related patients, such as patients having a type of pathology.

The system is designed to allow use by multiple users. For example, a second user can be introduced to alter the simulation parameters that a first user is experiencing. In one aspect, therefore, the system further comprises one or more monitors comprising one or more second user display interfaces for a enabling a second user (e.g., a trainer) to monitor a simulation that a first user is experiencing. The second user/trainer is provided with selectable options on the display of his or her user interface to enable the second user to alter or introduce variables (e.g., anatomical or physiological variables) in order to test or evaluate the responses or decision-making abilities of one or more first users. Alternatively or additionally, a second user may provide input into pretreatment planning. Because the system can be web-based, the second user does not have to be in the same physical location as the first user.

System and Method for Performing a Vertebroplasty Procedure

Vertebroplasty is a minimally invasive, percutaneous procedure for the treatment of osteoporosis and cancer related compression fractures of the spine. The procedure involves a physician using real-time X-ray imaging to guide the placement of a needle into a vertebral body of the spine. Radiopaque biocompatible bone cement (methyl methcrylate) is injected trough the needle to stabilize the vertebral body, relieve the associated pain associated with the condition and prevent further collapse of the bony tissue. The physician, usually a radiologist or surgeon, relies heavily on real-time X-Ray fluoroscopic images to determine the position of the lesion, to align and monitor the passage of the needle through various body tissues and to directly visualize the radiopaque cement injection process. This is a complex process that requires considerable hand-eye coordination and the physician's understanding of the 3-D anatomical relationships between various paraspinal tissues and their spatio-temporal intraoperative relationships to the real-time advancement of the interventional needles and devices. This requires considerable experience that is currently provided through on the job training by assisting experts during actual patient procedures or through practice sessions using cadavers. There is a critical need to provide additional physician and technician training for vertebroplasty procedures and a simulation system has great potential for this as well as for patient specific pretreatment planning.

The Workstation

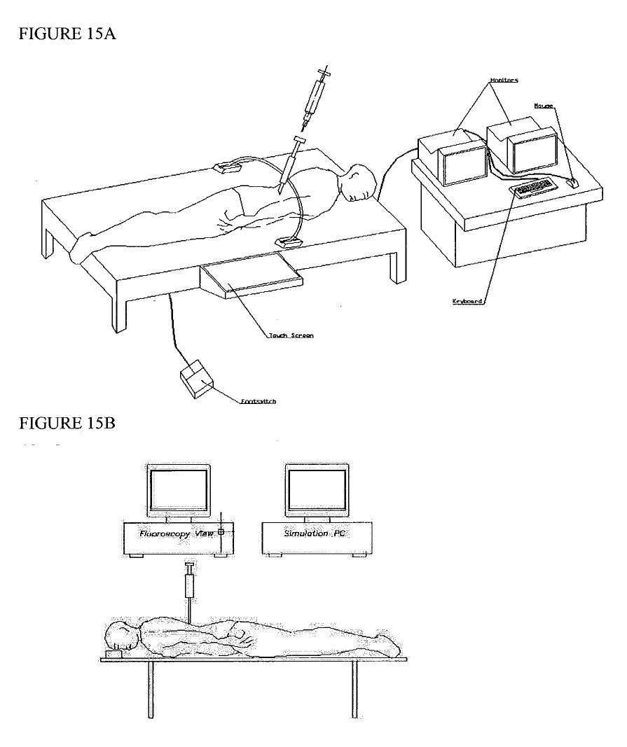

FIGS. 15A and B show a system comprising a workstation according to one aspect of the invention for performing a vertebroplasty procedure. The workstation comprises dual monitors, a manikin and a simulated syringe within attached spinal needle. A user loads a case that consists of CT and/or MRI volume images, and then examines the case by observing the interactively rendered fluoroscopic images on the fluoroscopy view monitor. The user can also examine the simulated patient-related physiological parameters such a blood pressure, heart rate or ECG on the second monitor. A second monitor displays volume rendered images and surface rendered reconstructed model. After examination, the user inserts the needle attached to the simulated syringe into a selected site surface on the manikin which comprises various insertion site locations along the back of the manikin over the spinal region. The user advances the needle through various body tissues including skin, muscle, fat and bone and then performs a simulated vertebroplasty on the simulated bony structure. After validation of correct needle position, e.g., with contrast injection, the user simulates the injection of cement by first removing the syringe with the needle intact and filling the syringe with cement.

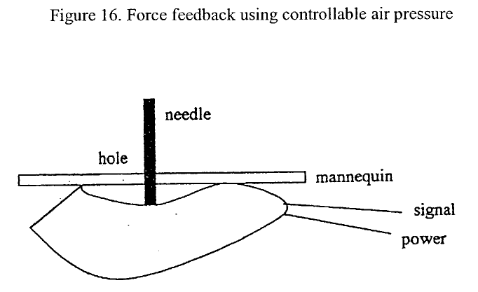

FIG. 16, shows an enlarged view of a force feedback mechanism provided in the medical device interface shown in FIG. 15B. A control signal determines the amount of resistance the user experiences as he or she pushes the needle through various body tissues. With a custom phantom, accurate feedback to a user can be achieved. The phantom comprises commercially available orthopedic models, or in certain aspects, models of collapsed vertebra or models of vertebrae exhibiting other pathologies (e.g., weakened by cancer or osteoporosis). These models can be cut, drilled, or tapped with hand- or powered-orthopedic instruments and are commonly used in surgical skills courses. In addition, in contrast to embalmed or fresh specimens, minimal clean up is required. The models can vary in porosity, which will give trainees using the vertebroplasty simulator better knowledge of the ‘feel’ to be expected from an osteoporotic patient and a normal patient. These models of the vertebra are placed in a custom-made aluminum holder, which conforms to the shape of the vertebra. The soft tissue in this custom phantom is constructed from a compound of polyvinyl chloride and a liquid plasticizer, phthalate ester. Soft tissue like materials, with Young's Modulus ranging from 10 kPa to 100 kPa, can be generated by varying the amount of phthalate ester to the polyvinyl chloride. This range of Young Modulus covers many of the body's soft elastic tissues.

The system provides a virtual display of 3D bone and soft tissue models created from X-ray, Computerized Tomography (CT), Fluoroscopy and Magnetic Resonance Imaging (MRI). The process of the bone cement injection is displayed in real time.

Modeling Needle Insertion

Needle insertion during vertebroplasty can be modeled using Finite Element (FE) method with high performance computing resources. The finite element formulation for needle insertion, is based on the assumption that as the needle advances into the vertebral body, its movement can be divided into a finite intervals. Each interval can therefore be assumed to be a static step. In addition, another assumption is made in regards to the mechanical properties of the cortical/cancellous bone. They are assumed to fail on the onset of plastic deformation; further analysis after plastic deformation is therefore not necessary. Thus, the FE analysis is based on a static linear analysis.

The weak form of equilibrium equations in 3-D problems, subjected to the boundary conditions, is given by:—

∫_{V}(\tilde{∇} [symbol] )^{T}σdV=∫_{S} [symbol] ^{T}tdS+∫_{V} [symbol] ^{T}bdV (1)

where v is an arbitrary weight vector and holds for any constitutive equation and \tilde{∇} is a matrix differential operator.

An FE formulation of 3-D elasticity is obtained to determine the stress-strain values during the needle insertion into the vertebral body. Defining a global shape function Nᵢ belongs to node point i, the displacement vector, u, over the entire body is:—

u=Na (2)

Where the global shape function matrix N has the dimension 3×3n, where n is the total number of nodes in the FE model of the vertebral body in question.

Using the Galerkin method, the weight vector v is chosen in accordance with

v=Nc (3)

As v is arbitrary, matrix c is arbitrary, from equation (2) we gather that

\tilde{∇} [symbol] =Bc where B=\tilde{∇}N (4)

Inserting equations (3) and (4) into (1), provides:—

c^{T}(∫_{V}B^{T}σdV−∫_{S}N^{T}tdS−∫_{V}N^{T}bdV)=0

As the c is arbitrary,

∫_{V}B^{T}σdV=∫_{S}N^{T}tdS+∫_{V}N^{T}bdV (5)

b has the dimension 3×1, N^{T}b therefore has the dimension 3n×1. The right hand side of equation (5) is the forces acting on the nodal points of the FE model of the vertebra by the vertebroplasty needle. The forces subjected to the nodal points have components in the x, y, z directions.

At this point, the required constitutive model are introduced. This model relates stress to strain, of the vertebra body, and vice versa.

σ=Dε−Dε₀ (6)

where D is the constitutive matrix and ε₀ contains the initial strains. Initial strains is dependent on the condition of the vertebral body and whether is subjected to other forces, prior to needle insertion.

Because ε=\tilde{∇}u, solving equations (2) and (4), gives ε=Ba.

And now equation (6) becomes

σ=DBa−Dε₀

And equations (5) now becomes

(∫_{V}^{B}^{T}DBdV)a=∫_{S}N^{T}tdS+∫_{V}N^{T}bdV+∫_{V}B^{T}Dε₀dV (7)

Now, boundary conditions would be taken into consideration. They are usually expressed in terms of prescribed traction vector t, natural boundary condition, or a prescribed displacement u, essential boundary condition. Using Cauchy's formula, t=Sn,:—

t=Sn=h on Sₕ

u=g on S_{g}

where h and g are known vectors. t is known along the boundary Sₕ and the displacement u is known along the boundary S_{g}. The total boundary S consists of S_{g} and Sₕ. With these noted, equation (7) becomes:—

(∫_{V}B^{T}DBdV)a=∫_{S}_{ₕ}N^{T}hdS+∫_{S}_{_{g}}N^{T}tdS+∫_{V}N^{T}bdV+∫_{V}B^{T}Dε₀dV

which is the formulation sought.

In compact form,

| | |
|---|---|
| K = ∫_{V}B^{T}DBdV = | stiffness matrix (dependent on mech- |
| property | anical of the cortical and cancellous |
| bone) | |
| f_{b} = ∫_{S}_{ₕ}N^{T}h dS + ∫_{S}_{_{g}}N^{T}t dS = | boundary vector (dependent on initial |
| conditions) | boundary |
| f₁ = ∫_{V}N^{T}b dV = | load vector (dependent on speed of |
| insertion) | needle |
| f₀ = ∫_{V}B^{T} Dε₀ dV = | initial strain vector (usually zero) |

If n is the total number of nodes in the FE model of the vertebra, then K has the dimension 3n×3n, a has the dimension 3n×1 and the right hand side (f_{b}, f₁, f₀) have a dimension of 3n×1. The forces are summed into a single force vector f.

f=f_{b}+f₁+f₀

Which gives the FE formula

Ka=f

Where f has the dimension of force. Standard principles to solving these equations can then be applied to solve the basic FE formula.

Modeling Cement Injection During Vertebroplasty

Most bone has both cortical or compact and trabecular or cancellous components. Cortical bone is very dense and tough while trabecular bone is a porous structure. In the modeling of trabecular bone for the stress analysis purpose, it is characterized as a cellular solid or foam. The process of vertebroplasty involves the distribution of a cement fluid under pressure throughout the trabecular bone, filling the gaps within it and providing strength. The trabecular bone is modeled herein as a structure like sponge with the following characteristics described quantitatively: relative density, vacancy density, resistance, the potential value, the potential contour region, volume filled by potential value, determination of the region filled by cement volume, and the calculation of the potential field.

Relative Density

The relative density describes the volume fraction of solids at each point. It determines how much cement the bone can absorb at this point and at the same time the resistance for the cement to pass it to its neighbors. The determination of the relative density at a point is based on its intensity in the volume image. However, the cortical bones behave significantly differently to the trabecular bone, and the image intensity of these two kinds of tissues cannot reflect such differences. Therefore, the type of the bone tissue must be defined. The relative density ρ can be expressed as,

ρ(x, y, z)=ρ(I(x, y, z), t(x, y, z))

in which I(x, y, z) is the image intensity while t(x, y, z) is the type at point (x, y, z). The range of relative density is defined as between 0.0 to 1.0. A density of 0.0 means that at this point, it is hollow. While density 1.0 means that it is fully solid.

The Vacancy Density

The vacancy density defines how much cement could be absorbed at point (x,y,z). The vacancy density at this point can be defined as

v(x, y, z)=1.0−ρ(x, y, z).

The Resistence

When cement is flowing from a first point (x₁y₁z₁) to a second point (x₂y₂z₂), it must overcome a resistence experience at the first point. The resistence at a point is characterized as a function of the relative density and the type of the bone material.

r(x,y,z)=r(ρ(x,y,z),t(x,y,z)).

The Potential Value

For a given target point (x,y,z) the total resistence the cement must overcome along the path from an injection point to the target point is defined as the potential value. Potential may be defined as

p(x, y, z)=∫_{C}r(ρ(s),t(s))ds

in which C is the path from the injection point that cement is taking and s is the increment along the path.

Potential Contour Region

Given a potentioal value P₀, the contour region of potential may be defined as:

R^{P}(P₀)={V(x,y,z)|V(x,y,z)∈R³ [symbol] p(x,y,z)=P₀}.

The potential contour surface determines the outmost surface that cement can reach corresponding to a given potential value. The process of cement injection is just the calculation of the potential contours corresponding to the increasing potential values.

Volume Filled by Potential Value

Given a potential value P, the volume of vaccancy for filling is determined by;

V(P)=∫∫∫_{R}_{^{P}}_{(P)}v(x, y, z)dv

If the potential value P₀, the volume of the vacancy the cement filled is

Vol(P₀)=∫₀^{P}^{₀}V(p)dp

### Determination of the Region Filled by Cement Volume

If the amount of cement injected into the bone is Vᵢₙ, the region filled by the cement can be determined by:

R^{V}(Vᵢₙ)={R^{P}(P)|P<P_{c}}

Vol(P_{c})=Vᵢₙ

The Calculation of Potential Field (Illustrated in 2D)

In the previous section, the formulae are expressed in a continuous form. However, in certain aspects, characteristics are for each voxel. For simplicity of expression, an implementation algorithm is described below in 2-D form. Thus, each voxel in the volume image is converted to a pixel in a plane image.

Eight neighbors of the point P.

| | | |
|---|---|---|
| n¹ | n² | n³ |
| n⁰ | P | n⁴ |

The neighbors of a pixel P in the bone region are the eight pixels denoted by nᵢ, i=0, 1, . . . , 7 as shown above and the set formed by them is denoted by N(P). The potential value for each point in the field is calculated from the distribution of resistance and the spatial distance. Each pixel P is assigned a value L(P) that is equal to the energy used for the cement to travel from the injection point O to a point (x,y,z). The two distance weights for the horizontal/vertical and for the diagonal neighbors are assumed to be d₁ and d₂ respectively. Letting r(P) represent the resistance value at point P, with the neighboring pixels illustrated as above, the potential value of P can be computed within two sequential raster scans, one forward and one backward.

Forward: from left to right, top to bottom:

$$L ( P ) = min \{ L ( {n}_{0} ) + {d}_{1} * r ( P ) , \\ L ( {n}_{1} ) + {d}_{2} * r ( P ) , L ( {n}_{2} ) + {d}_{1} * r ( P ) , \\ L ( {n}_{3} ) + {d}_{2} * r ( P ) \}$$

Backward: from right to left, bottom to top:

$$L ( P ) = min \{ L ( P ) , L ( {n}_{4} ) + {d}_{1} * r ( P ) , \\ L ( {n}_{5} ) + {d}_{2} * r ( P ) , L ( {n}_{6} ) + {d}_{1} * r ( P ) , \\ L ( {n}_{7} ) + {d}_{2} * r ( P ) \}$$

If there exists only one point nₖ∈N(P), which satisfies:

L(nₖ)=L(P)+d₁*r(nₖ) if k=0, 2, 4, 6; or

L(nₖ)=L(P)+d₂*r(nₖ) if k=1, 3, 5, 7;

point nₖ may be said to be adressed by P or that point P gives reference to nₖ.

As to the determination of distance metric d₁ and d₂, many kinds of metric can be used, among which Euclidean distance is the best to guarantee isotropy. Thus in one implementation, d₁=1.0 and d₂=1.414.

Graphic Rendering of a Vertebroplasty Procedure

Patient-specific volume data sets (X-rays, CT, or MRI scan) comprise vertebra structures, as well as other tissues and organs such as muscles, heart, kidney and so on. However, in an actual vertebroplasty process, X-ray fluoroscopic images are often used for the physicians to determine the position of lesion, and the images mainly focus on the spine of the patient. In one aspect, therefore, the technique of volume rendering is employed and implemented before the simulation procedure so that the representations of patient data can be showed as in the real vertebroplasty procedure.

During the procedure of cement injection, the intensity of voxels of patient-specific data sets from patients with osteoporosis or other fractures of the spine is modified (e.g., increased) dynamically for a real-time simulation. Before simulation procedures, an intensity value I₀, which represents the full density of the bone, must be defined. A pre-analysis of vertebra datasets can be applied for the determination of I₀ according to the maximum intensity of the data.

However, in order to enhance the differences between an area of cement and other areas of the spine, the cement-filled voxels are labeled with a different color from other areas of the spine to allow a health care worker to readily realize leakage or to determine if insufficient amounts of cement have been injected.

Therefore, it can be useful to use color in the rendering of a data set. Since most datasets do not have intrinsic color values assigned to voxels, only intensities, transfer functions can be employed to map a voxel intensity to a color (e.g., red, green or blue). This process is called shading (coloring) in the volume-rendering pipeline. The transfer functions may be represented as:

Rᵢ=Tᵣ(Iᵢ, . . . )

Gᵢ=T_{g}(Iᵢ, . . . )

Bᵢ=T_{b}(Iᵢ, . . . )

Where Tᵣ, T_{g} and T_{b} are the transfer functions for the colors red, green, and blue, respectively. These three transfer functions can be different from each other. Typically they are only a function of the voxel intensity.

In many applications of volume rendering techniques used in the invention, these transfer functions may be provided as lookup tables, which are used during the classification stage to assign color (together with opacity in most cases) to voxel data according to their intensities. So the selection of I₀ (which represents the full density) is expected to be unique. If there is more than one phase or step of cement injection involved, to render a cement-injected voxel from its original intensity to I₀, these different intensities that represent different phases of cement injection also need to be defined uniquely. In other words, such intensities do not exist in the volume data. Thus, the cement-injected voxels can be labeled with different colors and the simulation procedure can be more precisely controlled.

Generation of a Biomechanical Model

To build the potential field based on the volume data, a shortest-distance algorithm may be employed.

Shortest-Distance Algorithm

For a known graph

G=(V, E), V={v₁, v₂, . . . vₙ}where v₁, v₂, . . . vₙ represent all voxels and a distance matrix:

$$D = {( {d}_{ij} )}_{n \times n}$$

$${d}_{ij} = \{ \begin{matrix}( {v}_{i} , {v}_{j} ) & The distance from {v}_{i} to {v}_{j} \\ 0 & {v}_{i} = {v}_{j} \\ ∞ & Otherwise \end{matrix}$$

i,j=1, 2, . . . , n

The computation of shortest distance between any two points in the graph G is as following.

Given matrix A=(aᵢⱼ)_{n×n}, B=(bᵢⱼ)_{n×n}, the computation between matrices may be defined as

C=A*B=(cᵢⱼ)_{n×n}, cᵢⱼ=minₖ{aᵢₖ+bᵢₖ}, i,j=1, 2, . . . , n

and

AVB=(min(aᵢⱼ, bᵢⱼ)_{n×n}

Letting

D₍₁₎=D, D^{(k+1)}=D^{(k)}*D⁽¹⁾,

and

D*=D⁽¹⁾VD⁽¹⁾V . . . VD⁽¹⁾=(d*ᵢⱼ)_{n×n}

Then d*ᵢⱼ represents the shortest distance from vᵢ to vⱼ

Alternatively, for an initial distance matrix D;

do {

for (i = 1; i <= n; i++) {

for (j = 1; j <= n; j++) {

for (k = 1; k <= n; k++) {

dᵢⱼ = min {dᵢⱼ, dᵢₖ + dₖⱼ};

}

}

}

} while (at least one dᵢⱼ is changed)

The computational complexity of this algorithm is o(n³).

Building a Volume Based Potential Field

Representing all the voxels in the volume as v₁, v₂, . . . v_{n,} and defining a distance matrix:

$$D = {( {d}_{ij} )}_{n \times n}$$

$${d}_{ij} = \{ \begin{matrix}( {v}_{i} , {v}_{j} ) = Cost & If {v}_{i} and {v}_{j} are neighbours \\ - ∞ & {v}_{i} = {v}_{j} \\ + ∞ & Otherwise \end{matrix} \\ i , j = 1 , 2 , … , n$$

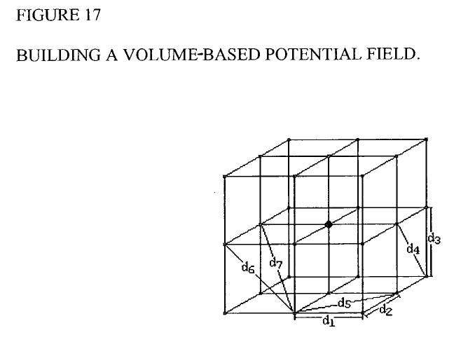

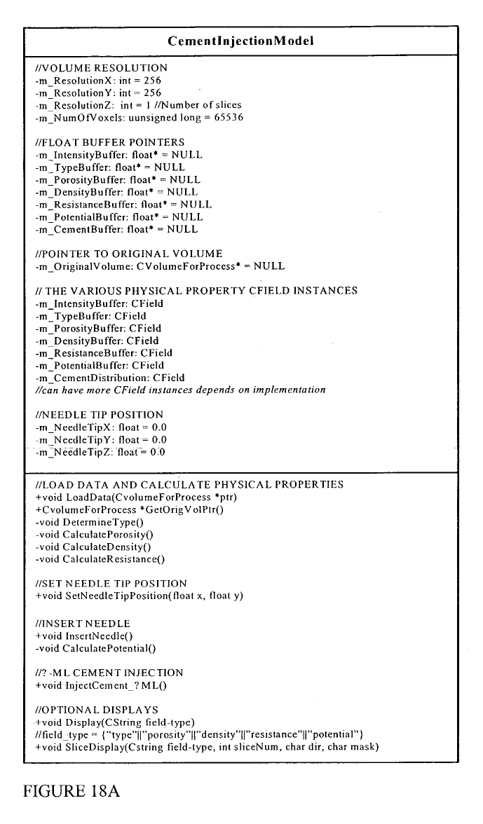

Voxels in the volume, except for those at boundaries, have 26 neighbors as showed in FIG. 17. A total 26 voxels are the neighbors of the center voxel.

Suppose voxel v₁ and voxel v₂ are neighbors, and their intensities are I₁ and I₂ respectively, then the definition of “Distance” (Cost) from v₁ to v₂ follows the rule:

Cost₁₂=d_{1->2}+(I₂−I₁)*t

Where:

d_{1->2}=d_{2->1}, a positive value. It is the real distance between v₁ and v₂, and it is one of the seven distance-values (d₁, d₂, . . . d₇) as shown above.

The positive value t, is a coefficient, which is related to the material type of the bone. This coefficient determines the proportion of distribution to the cost from v₁ to v₂ between the distance and the divergence of their intensities.

It should be noted that the Cost₁₂ could be either positive or negative.

Thus the initial distance matrix D is defined based on the volume data. Every row of this matrix has 26 cost values (boundary voxels may have less) and one −∞ cost value, and others are all +∞.

Secondly, following the above shortest-distance algorithm, the final result distance matrix D* is obtained. For every row of the matrix, for example the ith row, the d*ᵢⱼ represents the lowest cost from voxel vᵢ to any other voxel vⱼ.

Finally, the position of the injection origin O should be defined. With the distance matrix D*, all the costs from the injection origin O to any other points are known. These costs are attached to the destination voxels, and they are regarded as the potential value. Thus based on the volume data, the potential field has been derived. Different injection origins will have different potential fields.

It should be noted that in actual applications, only a sub-volume is involved in the computation of the shortest-distance algorithm. A subvolume is a portion of the volume. Instead of working on the entire volume, in one aspect, focus is on a subset of the volume where interaction between a tissue and medical device is taking place.

In this way, time complexity can be cut down remarkably and optimization of the process achieved. Additionally, in this algorithm, the surface definition of anatomic objects is not necessary. This feature enables a user to the system to discover the leakage or insufficient injection of cement during the simulation process because no surface is defined and no boundaries confine the flow of cement any longer.

Rendering Based on the Potential Field

During the procedure of vertebroplasty simulation, in the every iteration of the rendering process, the voxels with same potential value are rendered into “full density”. To provide a more realistic simulation procedure, iteration of the rendering process is divided into several phases, and the voxels with same potential value are increased to the I₀ (which represents the full density) in these phases step by step. Furthermore, in the every iteration of the rendering process, voxels with more than one potential value are considered. In other words, before the current voxels with a certain potential value are finished being rendering, the voxels with neighboring higher potential value are taken into process.

Mapping Functions

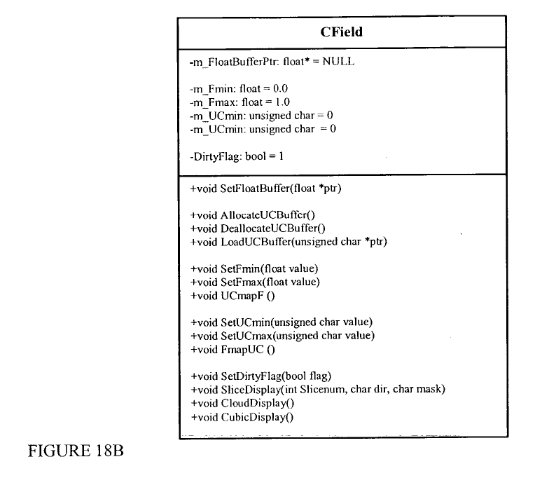

FIGS. 18A and B illustrate various mapping functions useful for determining property values for voxels. The mapping functions are implemented as follows.

FmapUC( )

float a=1/(Fmax−Fmin);
unsigned char b=UCmax−UC min;
for (int x ...){

for (int y ...){

for (int z ...){

UCdata = (unsigned char) ((Fdata−Fmin)*a*b + UCmin);

//arithmetic casting

...

UCmapF( )

float a=1.O/(1.0*(UCmax−UCmin));
float b=Fmax−Fmin;
for(int x ...){

for (int y ...){

for (int z ...){

Fdata = (1.0 * (UCdata−UCmin))*a*b + Fmin;

//arithmetic casting

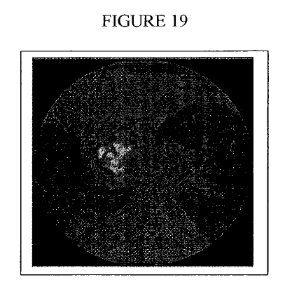

With these mapping functions, the properties at every part of the vertebra can be visualized. For example, in FIG. 19, the blue region on the image indicates the part of the vertebra with a density value greater than 8.0.

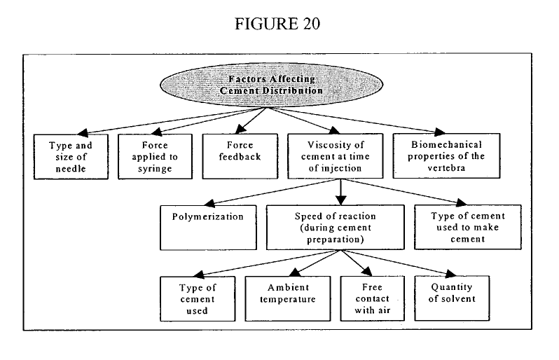

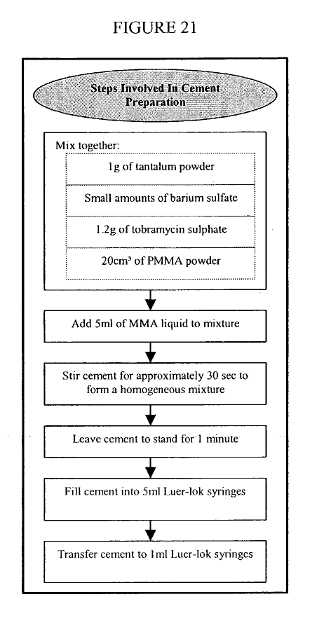

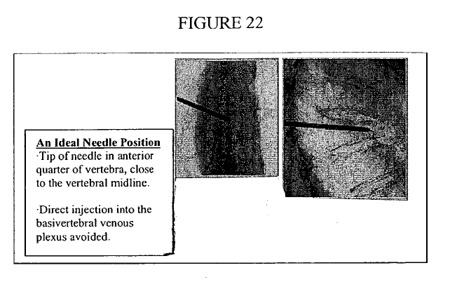

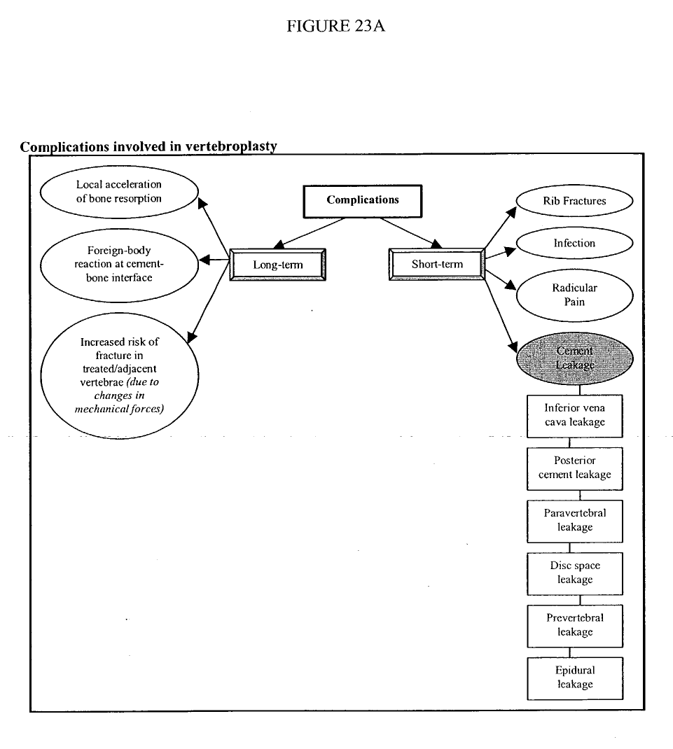

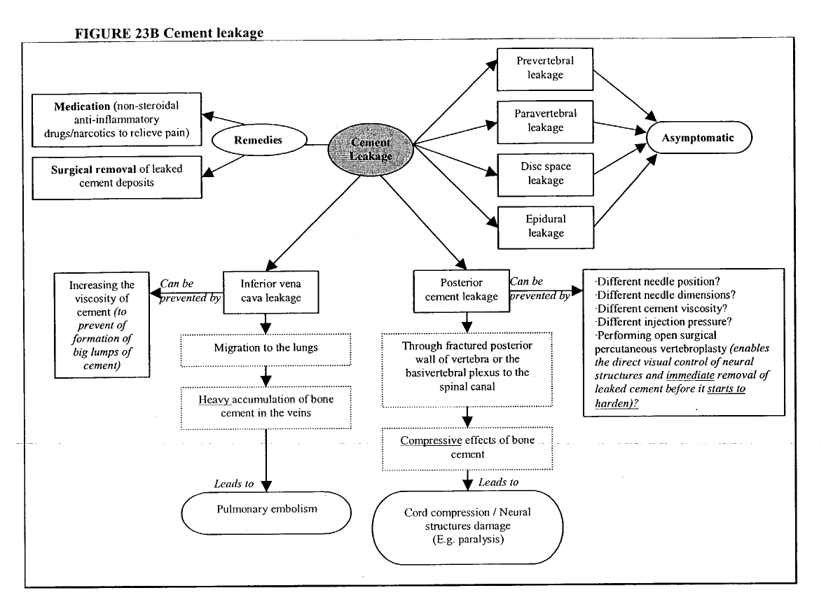

Various other properties can be modeled by the simulation system, all of which are factors affecting cement distribution as shown in FIGS. 20 and 21. These include, but are not limited to: the type and size of the needle, force feedback, viscosity of the cement at the time of the injection and biomechanical properties of the vertebra. Cement viscosity at the time of injection is influenced by such factors as polymerization, speed of the polymerization process during cement preparation and the type of cement used. The speed of the polymerization process depends on the type of cement used, ambient temperature, amount of free contact with air and the quality of solvent used. See, also FIG. 21. In one aspect, the simulation system database comprises data relating to one or more of these variables to enhance the accuracy of the simulation. The simulation system can be used in pretreatment planning to determine the ideal needle placement as shown for example, in FIG. 22. In still other aspects, the system may be used to simulate one or more complications which may ensue during a vertebroplasty procedure such as shown in FIGS. 23A and B.

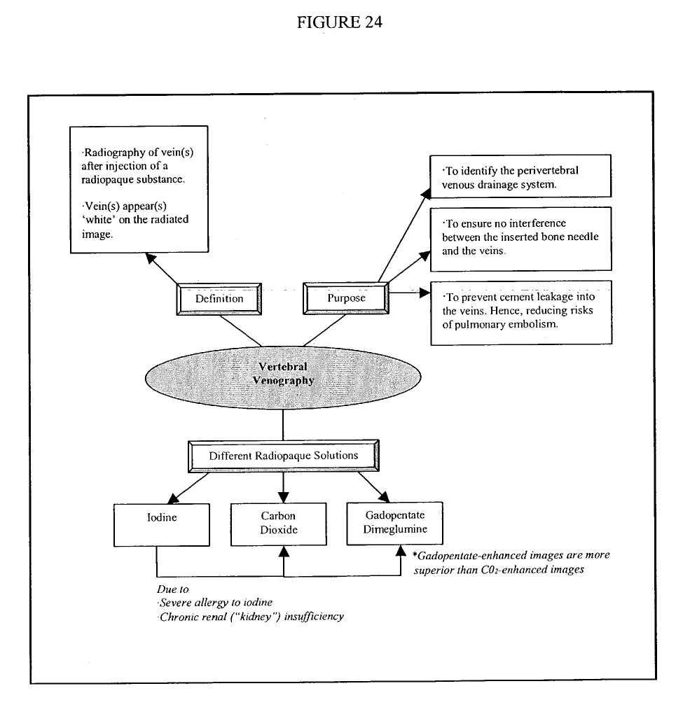

Although the above modeling exemplifies a vertebroplasty procedure, the same principles can be used to model other types of medical procedures and to compute forces at each node of interaction between a medical device and tissue. For example, the system may be used to simulate vertebral venography as shown in FIG. 24. Other medical procedures include procedures involving operations of medical devices including but not limited to: incision; dissection; injection; pinching, cutting, suturing, vertebroplasty; an orthoscopic procedure; biopsy; angiography; venography; arteriography; vertebral puncture; administration of an anesthetic such as during an epidural injection, delivery of therapeutic agents, grafting, transplantation, implantation, cauterization, reconstruction and the like. Procedures may include release of heat, light, ultrasound, or an electric field from a medical device, for example, as part of a therapeutic regimen. Therefore in certain aspects, the system database includes data relating to biomechanical properties of tissues after exposure to one or more of heat, light, ultrasound, or an electric field, and/or after exposure to a therapeutic agent (e.g., such as a drug or therapeutic molecule such as a nucleic acid, protein, etc).

System outputs include real-time representations of medical devices as they move through and interact with different tissues of a virtual patient's body.

Variations, modifications, and other implementations of what is described herein will occur to those of ordinary skill in the art without departing from the spirit and scope of the invention as described and claimed herein and such variations, modifications, and implementations are encompassed within the scope of the invention.

Each of the publications, patents, patent applications, and international applications referenced herein are incorporated in their entireties herein.

What is claimed is:

1. A system comprising:
a database comprising data for generating a geometric model of at least one tissue or organ and data relating to biomechanical properties of the at least one tissue or organ, wherein the at least one tissue or organ comprises heterogeneous biomechanical properties; and
a program for displaying an image of the at least one tissue or organ and for simulating interactions between a medical device and the tissue or organ.

2. A system comprising:
a database comprising data for generating a geometric model of a plurality of tissues and/or organs and data relating to biomechanical properties of plurality of tissues and/or organs;
a program for displaying an image of the plurality of tissues and/or organs and for simulating interactions between a medical device and the tissues and/or organs.

3. A system comprising:
an expert module comprising a database comprising data relating to biomechanical properties of at least one tissue or organ, wherein the at least one tissue or organ comprises heterogeneous biomechanical properties; and
a program for simulating a treatment method implemented by a medical device interacting with the at least one tissue or organ.

4. A system comprising:
an expert module comprising a database comprising data relating to biomechanical properties of a plurality of tissues and/or organs, wherein the at least one tissue or organ comprises heterogeneous biomechanical properties; and
a program for simulating a treatment method implemented by a medical device interacting with the plurality of tissues and/or organs.

5. The system of any of claims 1-4, wherein at least one tissue or organ is from a patient to be treated for a condition using the medical device.

6. The system of claim 6, wherein the condition is a pathology.

7. The system of claim 6, wherein the condition is an injury or wound.

8. The system of any of claims 1-4, wherein the database comprises data relating to properties of tissues or organs from a plurality of patients.

9. The system of any of claims 1-4, wherein the database comprises data relating to the interaction of a medical device with the at least one tissue or organ from at least one patient.

10. The system of any of claims 1-4, further comprising an interface for simulating contact between a user and the medical device.

11. The system of claim 10, wherein the interface communicates with the computer memory through a processor in communication with the database.

12. The system of any of claims 1-4, wherein the medical device is a needle.

13. The system of any of claims 1-4, wherein the system comprises program instructions for simulating an operation of the medical device on the body of a patient to diagnose and/or treat the patient for a condition.

14. The system of any of claims 1 or 4, wherein the operation comprises insertion of the medical device into at least one tissue or organ.

15. The system of claim 14, wherein the operation comprises insertion of the medical device into a plurality of tissues.

16. The system of claim 15, wherein the plurality of tissues comprise tissues having different biomechanical properties.

17. The system of any of claims 1-4, wherein at least one tissue comprises bone.

18. The system of claim 17, wherein the bone comprises cortical or compact bone and/or trabecular bone.

19. The system of claim 13, wherein the operation comprises removal of a biological material from a patient.

20. The system of claim 19, wherein the biological material comprises at least one cell suspected of comprising a pathology.

21. The system of claim 20, wherein the pathology is cancer.

22. The system of claim 13 or 19, wherein the operation comprises injection of a material.

23. The system of claim 13, wherein the operation comprises vertebroplasty.

24. The system of claim 13, wherein the operation comprises an orthoscopic procedure.

25. The system of claim 13, wherein the operation comprises a biopsy.

26. The system of claim 22, wherein the material comprises one or more agents selected from the group consisting of a nucleic acid, a virus, a peptide, a protein, a drug, a small molecule, an imaging agent, a chemotherapeutic agent, and a radiotherapeutic agent.

27. The system of any of claims 1-4, wherein the medical device comprises a probe for delivering ultrasound, radiowaves, photodynamic therapy, an electrical field, microwaves, x-ray therapy, and heat.

28. The system of claim 10, wherein the interface comprises a medical device and a manikin for receiving the medical device.

29. The system of claim 10, wherein the interface comprises a robotic arm coupled to the medical device.

30. The system of claim 10, wherein the interface comprises a needle assembly,

31. The system of claim 30, wherein the needle assembly comprises a curved frame.

32. The system of claim 10, wherein the interface comprises a mechanism for simulating resistance against insertion and/or movement of the medical device.

33. The system according to claim 10, wherein the mechanism is capable of varying the resistance.

34. The system of claim 10, wherein the resistance varies according to the simulated placement of the medical device in a given tissue type.

35. The system of claim 32 or 33, wherein the mechanism comprises a device for varying air pressure within the interface.

36. The system of claim 10, wherein the interface comprises a mechanism for providing continuous haptic feedback.

37. The system of claim 10 or 36, wherein the interface comprises a mechanism for providing directional feedback.

38. The system of any of claims 1-4, further comprising a graphical interface in communication with the database.

39. The system of claim 38, wherein the graphical interface displays an image of the at least one tissue or organ.

40. The system of claim 38, wherein the graphical interface displays an image comprising a plurality of tissues.

41. The system of claim 38 or 40, wherein the at least one tissue comprises cortical or compact and/or cancellous or trabecular bone.

42. The system of claim 38, wherein the image is a volume rendered image.

43. The system of claim 42, wherein the image is generated at least in part by finite element modeling.

44. The system of claim 39, wherein the graphical interface further displays an image of a simulated medical device interacting with the at least one tissue or organ.

45. The system of claim 44, wherein the graphical interface displays images simulating use of the medical device to treat a condition of the at least one tissue or organ.

46. The system of claim 45, wherein the images are displayed in real time.

47. The system of claim 39, wherein the graphical interface displays one or more controls for controlling the movement and/or operations of the medical device.

48. The system of any of claims 1-4, wherein the system further comprises an information management system for managing data within the database,

49. The system of claim 48, wherein the information management system comprises a search engine for retrieving data relating to a tissue or organ in response to a query from a user of the system.

50. The system of claim 48, wherein the information management system is capable of comparing data relating to different tissues and/or organs.

51. The system of claim 50, wherein the system further comprises a graphical user interface and wherein, in response to the comparing, the system displays a selected image of at least one tissue or organ.

52. A computer readable media containing program instructions, the program instructions comprising:
i. first computer program code for identifying an interface in communication with a processor, wherein the interface is capable of simulating contact between a user and the medical device; and
ii. a second computer program code for running an application, the application comprising instructions for simulating an operation of the medical device on at least one tissue or organ in the body of a patient, wherein the at least one tissue or organ comprises heterogeneous biomechanical properties.

53. A computer readable media containing program instructions, the program instructions comprising:
a) first computer program code for identifying an interface in communication with a processor, wherein the interface is capable of simulating contact between a user and the medical device; and
b) a second computer program code for running an application, the
application comprising instructions for simulating an operation of the medical device on at least one tissue or organ in the body of a patient, and for displaying:
i) an image of at least one tissue or organ comprising heterogeneous biomechanical properties or
ii) an image of a plurality of tissues and/or organs, wherein optionally at least one tissue or organ comprises heterogeneous biomechanical properties.

54. The computer readable medium of claim 52 or 53, wherein the patient has a condition to be diagnosed and/or treated by the operation.

55. The computer readable medium of claim 54, wherein the condition is a pathology.

56. The computer readable medium of claim 54, wherein the condition is an injury.

57. The computer readable medium of claim 54, wherein the operation comprises vertebroplasty.

58. The computer readable medium of claim 54, wherein the operation comprises an orthoscopic procedure.

59. The computer readable medium of claim 53, wherein the operation comprises biopsy of a tissue.

60. The computer readable medium of claim 52 or 53, further comprising a third computer program code for modifying the simulation based on the inputs received from the interface.

61. The computer readable medium of claim 52 or 53, further comprising program code for modifying the simulation based on patient data received.

62. The computer readable medium of claim 61, wherein patient data is received over the internet.

63. The computer readable medium of claim 61, wherein patient data comprises data relating to biomechanical properties of at least one tissue or organ in the patient.

64. The computer readable medium of claim 52, wherein the medical device comprises a needle.

65. A method for simulating a procedure implemented by a medical device, comprising:
a) providing a database comprising data relating to biomechanical properties of at least one tissue or organ;
b) performing at least one step of simulating the interaction of the medical device with
i) at least one tissue or organ comprising heterogeneous biomechanical properties; or
ii) a plurality of tissues and/or organs, wherein optionally at least one tissue and/or organ has heterogeneous biomechanical properties.

66. The method of claim 65, further comprising the step of operating the medical device to effect a diagnosis based on the simulating step.

67. The method of claim 65, further comprising the step of operating the medical device to treat a patient based on the simulating step.

68. The method of claim 65, further comprising simulating insertion of at least a portion of the device into a plurality of different tissues or organs comprising different biomechanical properties.

69. The method of claim 65 or 68, further comprising simulating insertion of at least a portion of the device into at least one tissue or organ comprising heterogeneous biomechanical properties.

70. The method of claim 65, wherein the at least one tissue comprises bone.

71. The method of claim 65, wherein the bone comprises compact and/or cancellous bone.

72. The method of claim 65, further comprising simulating the injection of a material into at least one tissue.

73. The method of claim 65, wherein the method comprises operating the medical device to remove a portion of at least one tissue.

74. The method of claim 65, wherein the database comprises data relating to a patient to be treated using the medical device.

75. The method of claim 65, wherein simulating the interaction comprises displaying one or more images of interactions between the medical device and at least one tissue.

76. The method of claim 75, further comprising providing an interface for simulating contact between a user and a medical device and wherein contact with the interface by the user alters display of the interaction.

77. The method of claim 76, wherein the method further comprises providing haptic feedback to the user through the interface.

78. The method of claim 65, wherein the device comprises a needle.

79. The method of claim 65, wherein the method further comprises the step of modeling tissue deformation.

80. The method of claim 65, wherein the method further comprises the step of modeling the motion of a tissue or organ upon interaction of the tissue or organ with the medical device.
